(19) United States
(12) Patent Application Publication
(10) Pub. No.: US 2005/0159688 A1
(43) Pub. Date: Jul. 21, 2005

(54) Massager and massaging method

(76) Inventors: Fumie Sakamoto, Hokkaido (JP); Chigiko Fujii, Nerima-ku (JP); Nobuko Sakamoto, Setagaya-ku (JP); Tomoko Sakamoto, Setagaya-ku (JP); Katsuhiro Sakamoto, Setagaya-ku Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/504,187

(22) PCT Filed: Feb. 10, 2003
(86) PCT No.: PCT/JP03/01391

(30) Foreign Application Priority Data
Feb. 12, 2002 (JP) 2002-34683

(51) Int. Cl. A61H 15/00

(52) U.S. Cl. 601/123; 601/125; 601/120

(57) ABSTRACT

This invention relates to a massager and a massing method. There has been known a conventional leg massager described in Japanese Utility Model Registration No. 3043777. However, there are great differences between individuals in their configurations of the legs, i.e. the above-knee and below-knee parts. Specifically, the shape of the leg portion from ankle to calf of leg differs greatly in individuals, the conventional massager has suffered a disadvantage such that it is difficult to massage the whole leg sufficiently with a single roller and the work becomes onerous where changing the roller in accordance with the shape of the leg. In the light of the foregoing disadvantages of the conventional massager, the present invention was made to provide a massager comprising stays connecting a plurality of rollers, and operating parts extending longitudinally from the stays. With the massager, a massage can be applied to the arm or leg of a user by handling the operating parts extending so as to incline the stays for adjusting the inclination of the stays, consequently to allow the rollers to conform to the shape of the arm or leg and exert massaging pressure on the arm or leg while rotating the rollers along the arm or leg without weakening the massaging pressure. Thus, the massage can be given to the entire aim and leg of the user in an unrestrained operation without restricting the posture of the user being massaged with the massager. In order to solve all of the conventional problems imposed by the conventional massagers, according to the present invention there is provided a massager comprising stays, operating parts formed on the stays, and roller means comprising a plurality of rollers, which are rotatably supported by the stays for holding an arm or leg between the rollers and adjustable in distance therebetween by handling the operating parts to change the inclination of the stays. That is, smooth rolling pressure can readily be given to the arm or leg by handling the operating parts to allow the rollers to conform to the configuration of the arm or leg and rotating the rollers along the arm or leg held between the rollers, while varying the inclination of the stays to adjust the distance between the rollers.

### TECHNICAL FIELD

This invention relates to a massager, and more particularly to a massager for promoting circulation of the blood and lymphocytes in arms and legs.

### BACKGROUND OF THE ART

There has been known a conventional leg massager described in Japanese Utility Model Registration No. 3043777.

The massager described in Japanese Utility Model Registration No. 3043777 comprises a pair of stays each provided at one end with a bent portion retaining a rotatable roller. The paired stays are joined in an X pattern with a connection pin. On the other end portions of the stays, there have been operating handles extending into the substantially same direction as the rotatable rollers.

The aforementioned conventional massager serves to apply a massage to the muscles of the above-knee and below-knee legs by putting the leg between the rollers and moving rollers on the leg.

However, although the aforesaid conventional massager serves to give a user a massage by using various types of rollers, there are great differences between individuals in their configurations of the legs, i.e. the above-knee and below-knee parts. Specifically, the shape of the leg portion from ankle to calf of leg differs greatly in individuals. Thus, the conventional massager has suffered a disadvantage such that it is difficult to massage the whole leg sufficiently with a single roller and the work becomes onerous where changing the roller in accordance with the shape of the leg.

Furthermore, since the rollers in the conventional massager are actuated to regulate the massaging pressure exerted on the leg portion by operating the handles of the paired stays joined in an X pattern, the massaging pressure exerted on the leg by moving the rollers along the leg is dispersed with the force for moving the rollers along the leg, consequently to weaken the pressure given to the rollers, resulting in insufficient massaging effect on the leg.

Moreover, in order to sufficiently massage the leg with the conventional massager noted above, the operating handles must be sturdily operated while firmly holding the long stays joined in an X form. Thus, since a user is restricted in posture during use of the conventional massager, the conventional massager turns out to have a disadvantage for the user who is going to apply a massage to his or her leg.

The conventional massager comprising the long stays is inconveniently cumbersome and difficult to use when massaging the above-knee part of the user's leg such as the thigh. A massage is given to the above-knee part of the user's leg by placing the massaging part of the leg between working parts of the massager formed of the stays joined in an X shape, and by forcing inward the operating handles so as to constrict the leg with the working parts of the massager. Thus, the conventional massager is inconveniently difficult to operate for effectively massaging the entire part of the leg.

In the light of the foregoing disadvantages of the conventional massager, the present invention was made to provide a massager comprising stays connecting a plurality of rollers, and operating parts extending longitudinally from the stays. With the massager, a massage can be applied to the arm or leg of a user by handling the operating parts extending so as to incline the stays for adjusting the inclination of the stays, consequently to allow the rollers to conform to the shape of the arm or leg and permit rolling pressure exerted on the part of the user to be massaged to be regulated by the use with ease while rotating the rollers along the arm or leg without weakening the massaging pressure. Thus, the massage can be given to the entire aim and leg of the user in an unrestrained operation without restricting the posture of the user being massaged with the massager.

### DISCLOSURE OF THE INVENTION

In order to solve all of the conventional problems imposed by the conventional massagers, according to the present invention there is provided a massager comprising stays, operating parts formed on the stays, and roller means comprising a plurality of rollers, which are rotatably supported by the stays for holding an arm or leg between the rollers and adjustable in distance therebetween by handling the operating parts to change the inclination of the stays.

That is, smooth rolling pressure can readily be given to the arm or leg by handling the operating parts to allow the rollers to conform to the configuration of the arm or leg and rotating the rollers along the arm or leg held between the rollers, while changing the inclination of the stays to adjust the distance between the rollers.

### BRIEF DESCRIPTION OF THE DRAWINGS

FIG. 1 is a perspective view showing a first embodiment (1) of a massager according to the present invention.

FIG. 2 is a perspective view showing first and second rollers in FIG. 1.

FIG. 3 is a right side view showing the massager 1 in use of FIG. 1.

FIG. 4 is a cross sectional view taken along X-X in FIG. 3.

FIG. 5 shows the state in which the massager 1 of FIG. 1 varies its inclination along the lower leg 200.

FIG. 6 is a front view of FIG. 3.

FIG. 7 shows the state of using the massager of FIG. 1 in another mode.

FIG. 8 is a perspective view showing a second embodiment (2) of the massager according to the present invention.

FIG. 9 is a perspective view showing a third embodiment (3) of the massager according to the present invention.

FIG. 10 is a perspective view showing a fourth embodiment (4) of the massager according to the present invention.

FIG. 11 is a perspective view showing a fifth embodiment (5) of the massager according to the present invention.

FIG. 12 is a perspective view showing a sixth embodiment (6) of the massager according to the present invention.

FIG. 13 is a perspective view showing a seventh embodiment (7) of the massager according to the present invention.

FIG. 14 is a cross sectional view taken along Y-Y in FIG. 13.

FIG. 15 is a perspective view showing an eighth embodiment (8) of the massager according to the present invention.

FIG. 16 is an enlarged view of the portion indicated by V of the massager of FIG. 15

FIG. 17 is a perspective view showing a ninth embodiment (9) of the massager according to the present invention.

FIG. 18 is a cross sectional view taken along Y1-Y1 in FIG. 17.

FIG. 19 is an enlarged view of the principal portion of the first roller in the massager of FIG. 18.

FIG. 20 is an enlarged view of the principal portion of an extension adjusting mechanism in the massager of FIG. 17.

FIG. 21 is an enlarged view of the principal portions of the operating part and handle in the massager of FIG. 18.

FIG. 22 is a perspective view showing a tenth embodiment (10) of the massager according to the present invention.

FIG. 23 is a perspective view showing the massager 100 of FIG. 22.

FIG. 24 is a right side view illustrative of the massager 100 of FIG. 22 in use.

FIG. 25 is an enlarged view of the portion indicated by Z of the massager of FIG. 24.

FIG. 26 is a right side view illustrative of the massager 100 of FIG. 22 in use.

FIG. 27 is a right side view illustrative of the massager 100 of FIG. 22 in use.

FIG. 28 is a perspective view showing an eleventh embodiment (11) of the massager according to the present invention.

### BEST MODE FOR CARRYING OUT THE INVENTION

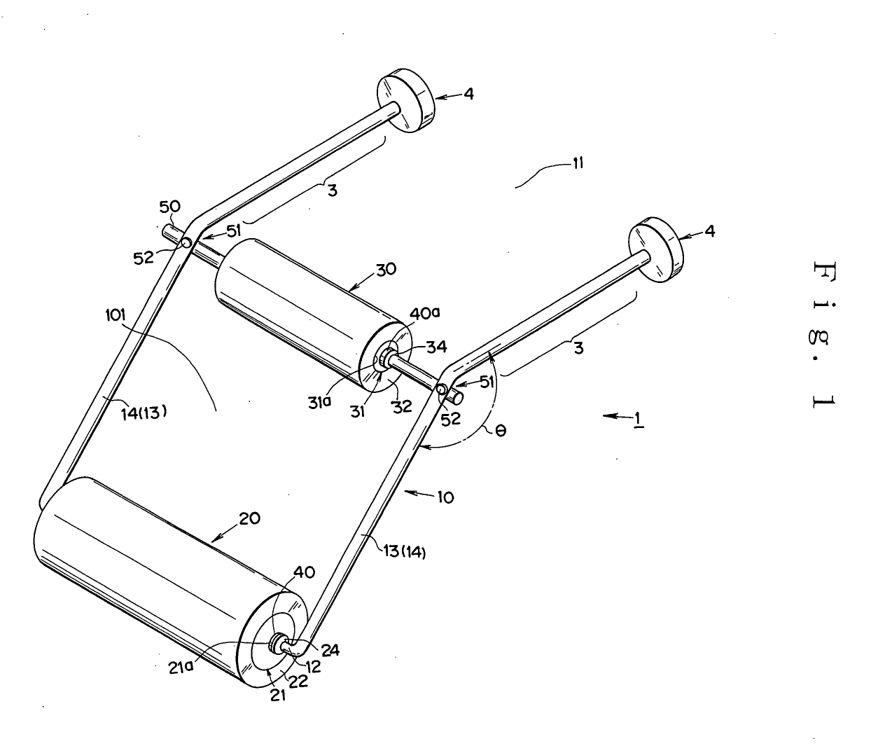

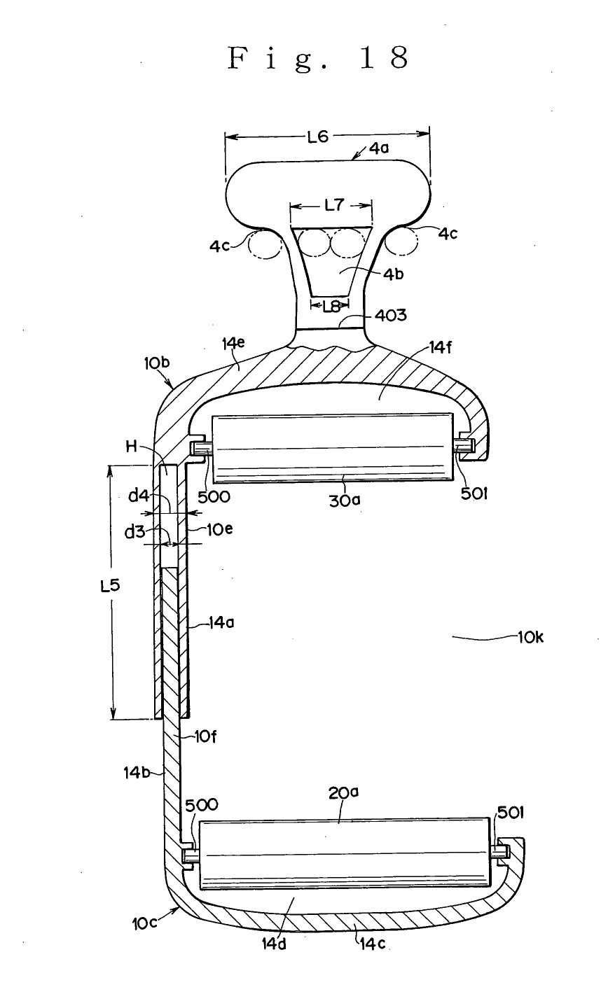

A massager and massaging method in the best mode carrying out the first embodiment according to the present invention will be described hereinafter with reference to FIG. 1 through FIG. 28.

The massager according to the present invention, which comprises stays, operating parts formed on the stays, and roller means rotatably supported by the stays, is featured by forming the roller means of a plurality of rollers, which can be operated to conform to the configuration of the arm or leg of a user and rotated along the arm or leg held between the rollers by handling the operating parts to change the inclination of the stays, consequently to adjust the distance between the rollers and regulate the massaging pressure exerted on the leg portion.

Thus, the distance between the rollers arranged for holding the arm or leg therebetween can be adjusted by handling the operating parts to fit the rollers to the shape of the arm or leg of the user and changing the inclination of the stays, so that the rollers are rotatable along the shape of the arm or leg to regulate the massaging pressure exerted on the leg portion.

The rollers in the aforesaid massager of the invention can simultaneously exert massaging pressures on the arm or leg in different directions as they roll along the arm or leg.

According to the massager of the invention, the arm or leg held between the rollers can be effectively massaged with the rolling pressure brought about by the rollers from all directions at one time.

The massager of the invention is further featured by extending the operating parts from the stays at the desired angle.

With this arrangement of the operating parts extending from the stays at the desired angle, the inclination of the stays can be increased by handling the operating parts so as to place the operating parts close to the user.

The rollers in the massager of the invention are each formed of a roller main body connected rotatably to the stays, and a protection member covering the roller main body.

The rollers formed of the main body covered with the protection member can lessen a burden on the arm and leg to be massaged and protect the arm and leg of the user. Besides, the rollers can be reliably connected to the stays with the roller main body.

The aforesaid protection members on the rollers of the massager according to the invention may be made of elastic materials having different penetration rates.

With the rollers covered with the protection members having different penetration rates, rolling pressures having different strengths can be exerted on the arm and leg.

Furthermore, the stay in the massager of the invention may be provided with a mount adjusting mechanism for changing the locations of the rollers.

With the mount adjusting mechanism in the massager of the invention, the locations of the rollers for holding the arm or leg therebetween can be adjusted to conform to the arm and leg of the user, which differ in individuals, so that the distance between the rollers can be adequately initialized before use.

The massager of the invention is further featured by the stays having an extension adjusting mechanism.

The stays having the expansion adjusting mechanism make it possible to be lengthened or shortened in accordance with the posture of the user to be massaged and to place the operating parts close to the user. Moreover, with the stays having the expansion adjusting mechanism, the distance between the rollers can be adjusted to conform to the size of the arm or leg of the user.

The massager of the invention is further featured in that the stays placed between the rollers are each provided with a spring member.

With the stays having the spring members, the rolling pressure produced in rotating the rollers along the arm or leg can be regulated by means of the spring members, thus to make it easier to adjust the inclination of the stays and the distance between the rollers.

The massager of the invention is further featured in that the roller means may comprise a first roller mounted on one ends of the stays opposite to the operating parts, and a second roller disposed between the operating parts and the first roller, so as to hold the arm or leg of the user with the first and second rollers from two directions.

Since the first and second rollers in the aforementioned massager function as a lever having a fulcrum and a point of action, the rolling pressure can be appropriately produced with the first and second rollers with high efficiency by handling the operating parts without producing an excessive force from a force loaded on the operating parts serving as the point of action.

The present invention further provides another massager comprising stays, operating parts formed on the stays and having a handle arranged in substantial parallel to the roller, and a roller rotatably supported by the stays and provided on its both sides with running wheels, which are larger in diameter than the roller and rotatable independent of the roller. The aforesaid roller is integrally assembled with the running wheels on a mount part formed in the stay, so as to define an insertion portion framed by the stay member and the roller for allowing the arm or leg to be inserted thereinto. The roller in contact with the arm or leg is rotatable along the arm or leg independent of the running wheels. A relation between a distance L3 from the handle to the roller and a length L4 of the mount part is L3>L4.

According to the massager having the running wheels independent of the roller, the roller is movable along the arm or leg, which is steadily placed on the roller, substantially in the same direction as that in which the handle is manipulated, and the reaction force is produced on the roller rotating independent of the running wheels by the weight of the arm or leg and applied to the arm or leg on the rotating roller. Besides, the roller can smoothly move along the arm or leg inserted into the insertion portion.

Furthermore, the massager according to the invention comprises a stay member, an operating part formed on said stay member, and roller means rotatably supported by said stay member. The aforesaid operating part has a handle arranged substantially parallel to the roller, and the roller is provided on its both ends with running wheels rotatable independent of the roller, which are larger in diameter than the roller and rotatable independent of the roller. The roller is integrally assembled with the running wheels on a mount part formed in the stay, so as to define an insertion portion framed by the aforesaid stay member and the roller means. The aforesaid running wheels are detachable.

The massager having the running wheels independent of the roller is characterized in that the roller is movable along the arm or leg, which is steadily placed on the roller, substantially in the same direction as that in which the handle is manipulated so as to produce the reaction force on the roller roating independent of the running wheels by the weight of the arm or leg and applied to the arm or leg on the rotating roller. The oller can stably move on along the arm or leg steadily placed thereon with the running wheels, to securely exert the resultant rolling pressure on the arm or leg. The detachable running wheels in this massager can be replaced with other wheels having a different diameter.

Next, the massager and massaging method in the best mode for carrying out the first invention will be described with reference to the accompanying drawings.

FIG. 1 through FIG. 7 show the first embodiment (1) of the massager according to the present invention.

The massager 1 in the first embodiment (1) comprises a stay member 10, a first roller 20 and a second roller 30 supported by the stay member 10, operating parts 3 extending longitudinally from the stay member 10 placed between the rollers. The stay member 10, first roller 20, second roller 30 and operating parts 3 are integrally assembled.

The stay member 10 is generally formed in a square U shape and desirably made of a pipe. The substantial U shaped stay member 10 is composed of an opening part 11, a basal part 12 opposite to the opening part 11, and side parts 13 and 14 adjacent to the basal part 12. To the side parts 13 and 14, there are connected operating parts 3 described later. The basal part 12 is made larger than the length of a first roller 20 described below.

The first roller 20 comprises a roller main body 21 and a protection member 22.

The roller main body 21 has side grooves 21a each for accommodating a bearing 40 having a center hole 41 through which the stay member 10 is inserted, and an insertion hole 21b for inserting the stay member 10 therethrough. It is desirable to make the roller main body 21 of rigid material such as metal or plastic.

The protection member 22 is made of elastic material and has a thickness w1 with a penetration rate α. The protection member 22 covers the outer circumferential surface of the roller main body 21 as a coating.

The second roller 30 comprises a roller main body 31 and a protection member 32.

The roller main body 31 has side grooves 31a each for accommodating a bearing 40a having an insertion hole 31a. The bearing 40a has a center hole 41a through which a connection bar 50 connected to the stay member 10 with connection pins 51 is inserted into an insertion hole 31b formed in the second roller 30. Similarly to the roller main body 21, it is preferably made of rigid material such as metal or plastic. The connection bar 50 is made longer than the roller main body 31 and formed of a steel pipe or the like as the stay member 10 is.

The protection member 32 is made of elastic material and has a thickness w2 with a penetration rate β. The protection member 32 covers the outer circumferential surface of the roller main body 31 as a coating. The thickness w2 is made larger than the thickness w1 of the protection member 21, i.e. w1<w2.

The first roller 20 thus constructed is rotatably supported by the stay member 10 through the bearings 40 mounted on both sides of the basal part 12 of the stay member 10. Further, on both sides of the basal part, lock sleeves 24 are disposed for preventing rickety of the first roller 20 with the basal portion 12. Into the insertion hole 31b in the second roller 30, the connection bar 50 is inserted through the bearings 40a. The connection bar 50 is integrally connected to the junctions 52 of the stay member 10 with the connection pins 51. The second roller incorporates lock sleeves 24 for preventing rickety similarly to the first roller 20. The roller main body 21 and the protection member 21 each have a width D1, and the roller main body 31 and protection member 31 each have a width D2.

Each operating part 3 extends from the junction 52 at which the second roller 30 is connected to the stay member 10 to the end of the side part 13 or 14 of the stay member 10. Suppose that the length from the basal part 12 to the junction 52 is expressed by L1 and the length from the junction 52 to the end of the side part 13 or 14 of the stay member 10 is expressed by L2; L1<L2.

On the ends of the side parts 13 and 14 of the stay member 10, there are formed handles 4 each formed in a cylindrical shape. It is desirable to make the handle 4 of synthetic resin or wood so as to have a size and shape easy to grip and a smooth surface.

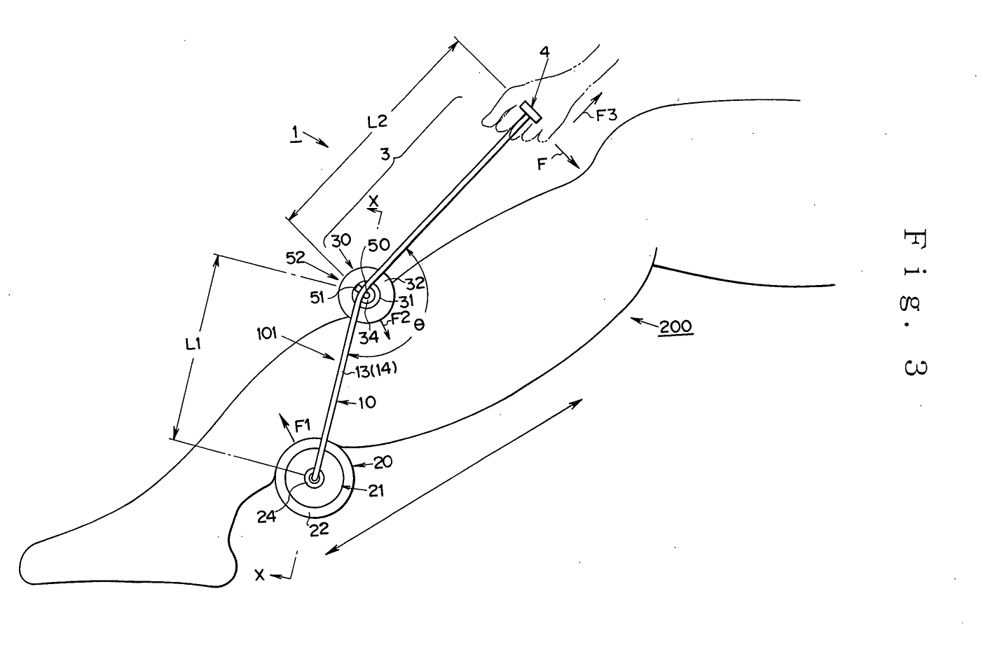

As shown in FIG. 3, the stay member 10 is bent at the junctions 52 so as to incline the operating parts 3 extending from the stay member 10 at an angle θ. The operating parts 3 can be inclined within the angle θ with elasticity of the stay member 10.

According to the massager 1 of the first embodiment (1) of the invention, the leg 200 of a user, which is inserted into and steadily held between the first roller 20 and second roller 30, can be massaged by manipulating the operating parts 3 to promote circulation of blood and lymphocyte in the entire leg 200 including the upper thigh and lower thigh.

Next, the usage of the massager 1 will be described.

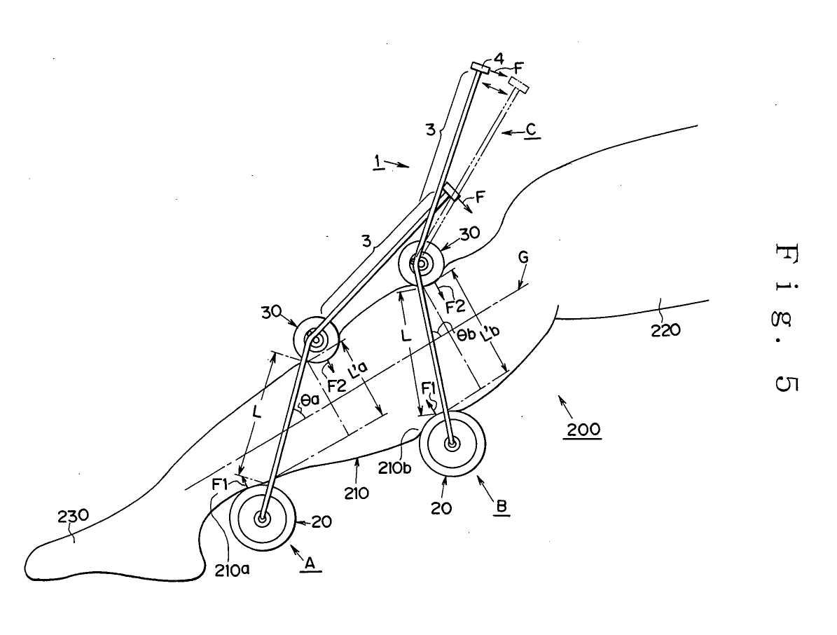

Upon inserting the leg 200 into an insertion portion 101 formed between the first roller 20 and the second roller 30 from the acute side defined by the stay member 10 bent at the junctions 52, the handles 4 at the ends of the operating parts 3 are gripped with both hands. The vertical height between the first roller 20 and second roller 30 relative to the stay member 10 is expressed as a roller-to-roller distance L.

Where the massager 1 assumes the state A of holding the calf 210 on the toe side 230 of the lower leg 200 as shown in FIG. 5, a base line G is determined as a reference axis of the lower leg 200. The stay member 10 between the first roller 20 and second roller 30 of the massager 1 in the state A is inclined at the angle θa relative to the base line G. Thus, assume that the vertical distance between the first roller 20 and the second roller 30 relative to the base line G is defined as a roller-to-roller distance L′, a roller-to-roller distance L′a in the state A becomes L·sin θ a. That is, the roller-to-roller distance L′a is adjusted so as to allow the first roller 20 and second roller 30 to conform to the shape of the calf 210 of the lower leg 200, consequently to be made shorter than the roller-to-roller distance L. When turning to the state B in which the first and second rollers 20 and 30 rotate along the lower leg 200 having an undulating surface and move to the central calf 210b larger than the lower calf 210a (State A), the stay member 10 is inclined toward the toe 230 relative to the base line G to increase the inclination to an angle θb larger than the angle θa in the state A relative to the base line G, so that the roller-to-roller distance L′b (=L·sin θ b) in the state B is adjusted to be larger than the roller-to-roller distance L′a. At this time, the first roller 20 and second roller 30 along the lower leg 200 are moved while handling the operating parts 3 to incline the stay member 10 to conform to the shape of the lower leg 200.

Next, the pressure forces with the rolling first and second rollers 20 and 30 exerted on the lower leg 200 will be described.

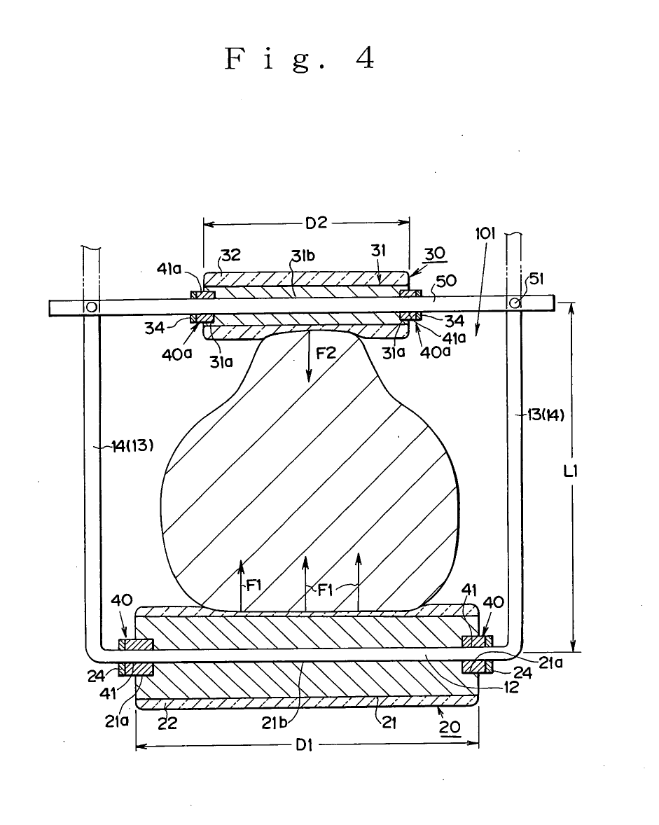

As shown in FIG. 3 and FIG. 4, the first roller 20 and second roller 30 are in press contact with the lower leg 200 to exert pressure forces F1 and F2 on the lower leg. That is, the pressure force F2 is forcibly applied to the upper surface of the lower leg 200 as the handles 4 (operating parts 3) serves as a power point, the second roller 30 being press contact with the upper surface of the lower leg 200 serves as a fulcrum, and the first roller 20 serves as a point of application, which constitute a leverage. Similarly, with the pressure force F acting downwardly on the handles 4 (operating parts 3) serving as the power point, the pressure force F1 applied to the lower surface of the lower leg 200 is brought about by the action of the first roller 20 serving as the point of application. Hence, the as shown in FIG. 5, the massager 1 is moved along the lower leg 200 while changing the inclination of the stay member 10 by manipulating the handles 4 (operating parts 3) to adjust the roller-to-roller distances L′a and L′b, consequently regulating the pressure forces F1 and F2 brought about by the first and second rollers 20 and 30 and applied to the lower leg 200. When applying the pressure forces F1 and F2 to the lower leg 200, the lower leg 200 is safely protected from excessive pressure force with the elastic protection members 22 and 32 covering the outer circumferential surfaces of the first and second rollers 20 and 30. The pressure force F acting downwardly on the handles 4 of the operating parts 3 can be controlled to regulate the pressure forces F1 and F2 by adjusting the roller-to-roller distances L′a and L′b with the handling of the operating parts 3 so as to adjust the inclinations θa and θb of the stay members 10 relative to the base line G.

Hence, the massager 1 in the first embodiment (1) of the invention can be effectively operated to make the roller-to-roller distance L′ shorter or longer by manipulating the operating parts 3 to incline the stay member so as to conform to the shape of the lower leg 200 relative to the base line G, thus to allow the rollers to smoothly move along the lower leg 200 while rotating irrespective of the fixed roller-to-roller distance L. Since the lower leg 200 is inserted into the insertion portion 101, the lower leg 200 is prevented from falling out of the massager 1 and stably held with the massager when changing the inclination of the stay member 10 to adjust the roller-to-roller distance L′, consequently to effectively massage the lower leg 200 with the first and second rollers 20 and 30.

The lower leg 200 held between the first and second rollers 20 and 30 receives rolling pressures brought about by the rollers from two directions at one time, consequently to not only promote circulation of blood in the entire leg 200 and circulation of lymphocyte in a lymphatic system having no circulating pump corresponding to a heart in a blood circulating system, but also loosen up the muscles or the like. Thus, the massager of the invention makes it possible to renovate resiliency and flexibility of the lower leg 200. Furthermore, when moving the massager 1 along the lower leg 200, the pressure forces F1 and F2 brought about by the first and second rollers 20 and 30 by the lever action can be applied to the lower leg 200 without dispersing to the force F3 required for moving the massager 1.

The attitude of the massager 1 in use can adapt to a variety of aspects such as a sitting state on a chair or a floor drawing up the knees or other possible states. Thus, the massager 1 is by no means restricted to any aspects and applications.

The first roller 20 and second roller 30 have the roller main bodies 21 and 31 covered with the protection members 22 and 32 having different penetration rates and thicknesses, so that the lower leg 200 can be suitably protected with the protection members having the relation α<β in penetration rate in accordance with the difference in elasticity of the relatively harder upper portion and relatively softer lower portion of the lower leg 200. Even if α=>β, the protective action in the massager of the invention is in no way affected by this relation.

Further, the protection members 22 and 32 having the relation w1<w2 in thickness can improve their cushion effects. If the protection members have the same penetration rate, the protection member 32 having large deformation modulus can bring about a moderate cushioning effect on the lower leg 200, consequently to effectively massage the lower leg. Of course, even if w1>=w2, the protective action in the massager of the invention is in no way affected by this relation.

Since the first and second rollers 20 and 30 are attached to the stay member 10 through the bearings 40 and 40a fitted in the roller main bodies 31 and 41, the rollers can be stably retained, so that a suitable massaging pressure to be exerted on the lower leg 200 can be effectively produced.

As the stay member 10 is bent at the junctions 52 to allow the operating parts to be positioned near the user, the massager in use is invariably positioned close to the lower leg 200 without the need for having constrained access to the lower leg, consequently to enable stable operation of the massager. Therefore, the massager of the invention can be used with taking up little space even on a train, airplane or the like in long periods of time. Since the lower leg 200 is massaged from above and beneath with the first and second rollers 20 and 30 at one time, the massager can achieve an effective massaging effect in a short period of time, and therefore, comfortably used even in a business office or the like.

Furthermore, the operating parts 3 are inclinable due to the elasticity of the stay member 10 so as to cause the stay member 10 in the state B to come to the state C in which the stay member 10 is inclined, while maintaining the positional relation between the lower leg 200 and the massager 1, just as one example, as shown in FIG. 5. Thus, the pressure force F applied to the handles 4 is transmitted directly to the first and second rollers 20 and 30, consequently to prevent the lower leg 200 from being constricted excessively. That is, the pressure force applied to the handles 4 is gently and quietly transmitted to the first and second rollers 20 and 30 due to the cushion effect brought about by inclining the stay member.

In addition, since the massager of the invention has a structure in that the relation between the length L1 from the base portion 12 to the junction 52 and the length L2 from the junction 52 to the end of the side portion 13 or 14 is L1<L2, consequently to form a leverage capable of producing a moderate pressure force exerted on the lower leg 200 from a minimum force applied to the handles 4 without impair the function of the pressure force F3 moving along the lower leg 200. Thus, the massager 1 of the invention has an excellent motility and operationality. Since the operating parts 3 each have the handle 4 at the end thereof, the pressure force applied to the lower leg 200 can easily be controlled. Even when the relation between the aforesaid lengths is L1>=L2, the leverage action in the massager of the invention is in no way affected by this relation.

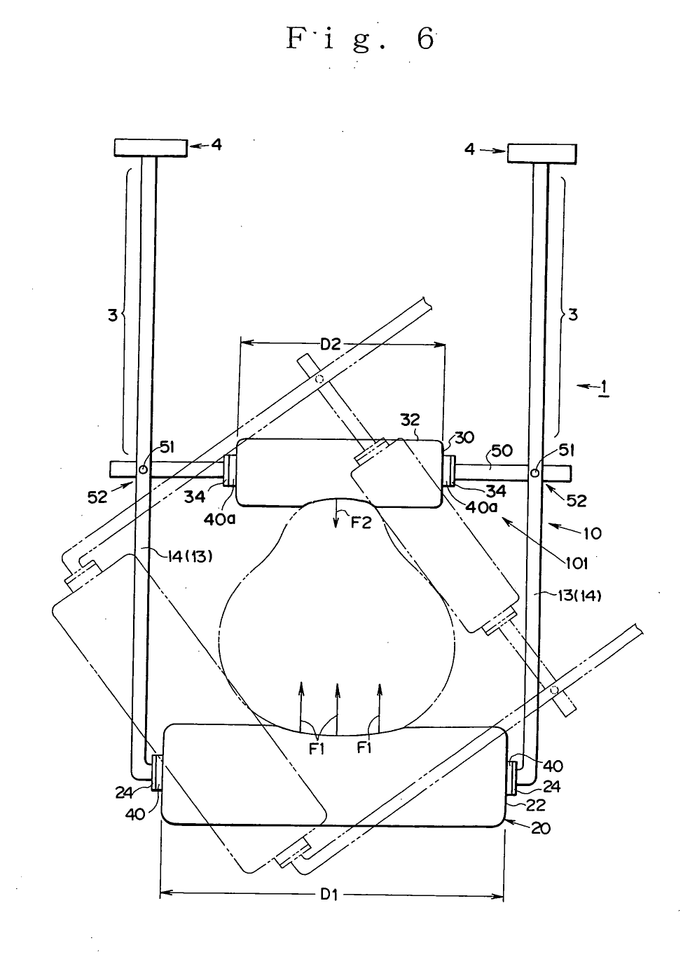

Further, since the relation between the widths of the first and second rollers 20 and 30 is D1>D2 as shown in FIG. 6, a moderate pressure force can be applied to the lower leg 200 without incurring waste, so that the first and second rollers 20 and 30 putting the lower leg 200 therebetween can easily be moved in the direction of the side of the lower leg 200. As a result, since the first roller 20 is longer in width than the second roller 30, the direction in which the pressure forces brought about by the rollers are applied to the lower leg 200 can be changed with ease in massaging the side portions of the lower leg 200, consequently to enable a smooth massage applied to the entire lower leg 200. Even when the relation between the aforesaid lengths is D1<=D2, the operation of the massager of the invention is in no way affected by this relation.

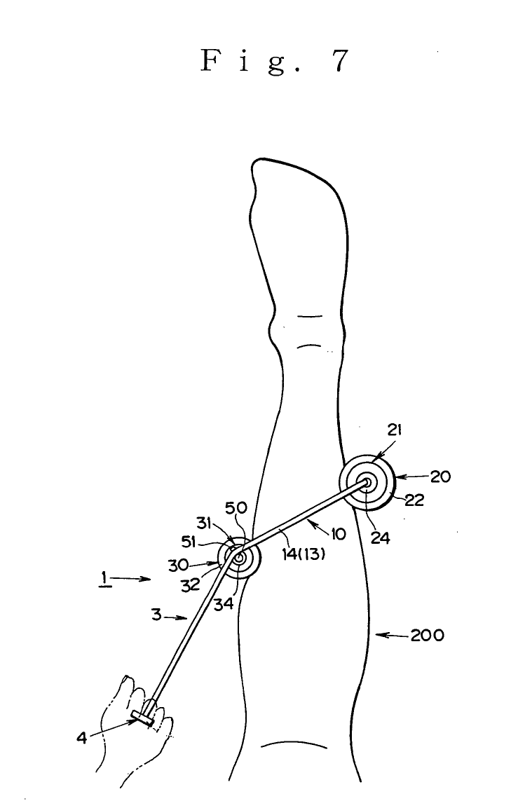

As shown in FIG. 7, the rolling pressure to be applied to the sides of the lower leg 200 can freely be moved along the lower leg 200 as the lower leg 200 is inserted into the insertion portion 101 formed between the first and second rollers 20 and 30 and held from the sides of the lower leg with the rollers. Thus, the operation of the massager in moving the rollers along the lower leg 200 can be carried out by handling the operating parts 3 without taking a labored posture in using the massager, consequently to enable a smooth massage with the massager 1 having an excellent operational performance.

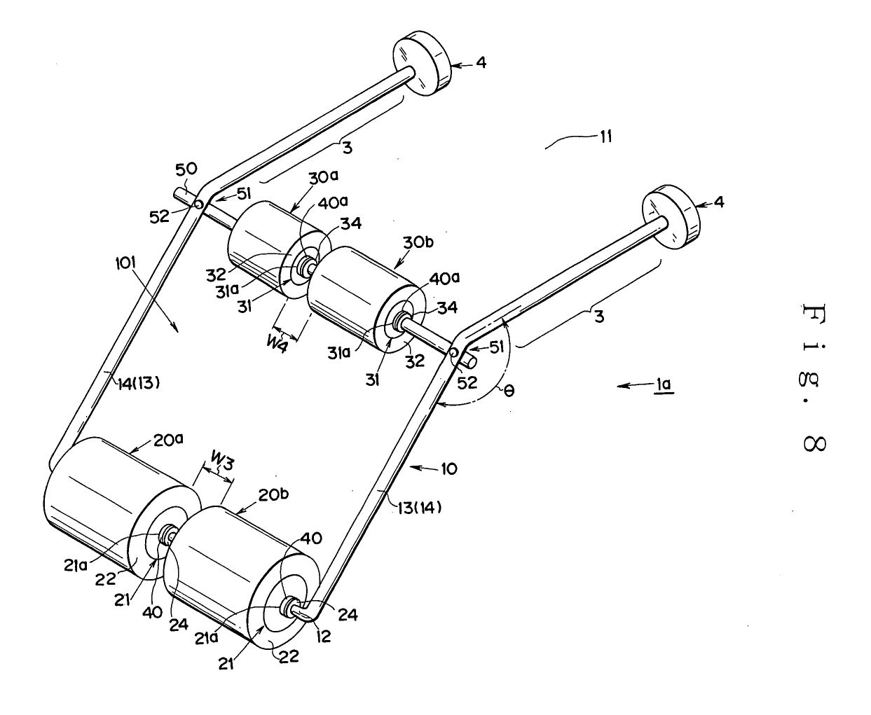

FIG. 8 illustrates the second embodiment (2) according to the present invention.

The massager in the second embodiment (2) comprises four rollers, i.e. first rollers 20a and 20b and second rollers 30a and 30b, which may be formed by dividing the first and second rollers 20 and 30 in the first embodiment (1).

A stay member 10 in this embodiment is formed in the same manner as that in the aforementioned first embodiment (1). The first rollers 20a and 20b are mounted on the base portion 12 of the stay member 10 at a distance of w3. The second rollers 30a and 30b are supported by the stay member 10 through the connection bar 50 at a distance of w4. The other component elements including roller main bodies, protection members and bearings are the same as those in the first embodiment (1) mentioned above.

In the massager 1a thus constructed in the second embodiment (2), the first rollers 20a and 20b and second rollers, which are placed at the distances w3 and w4, are independently rotatable in moving along the lower leg 200, to allow the rollers to come in close contact with the irregular surface of the lower leg 200 while rotating at different rotational speeds (angular rates). Consequently, a pressure force suitable for parts of the lower leg 200 with which the can be effectively applied thereto. Since the setting distances w3 and w4 have a function of allowing a reaction force caused by the pressure applied to the portion of the lower leg with the rollers to let out, so that the cushioning action of the protection members of the rollers can be encouraged to improve the massaging effect of the massager 1a. Other functions and effects of the massager in this embodiment are the same as those in the first embodiment (1) described above.

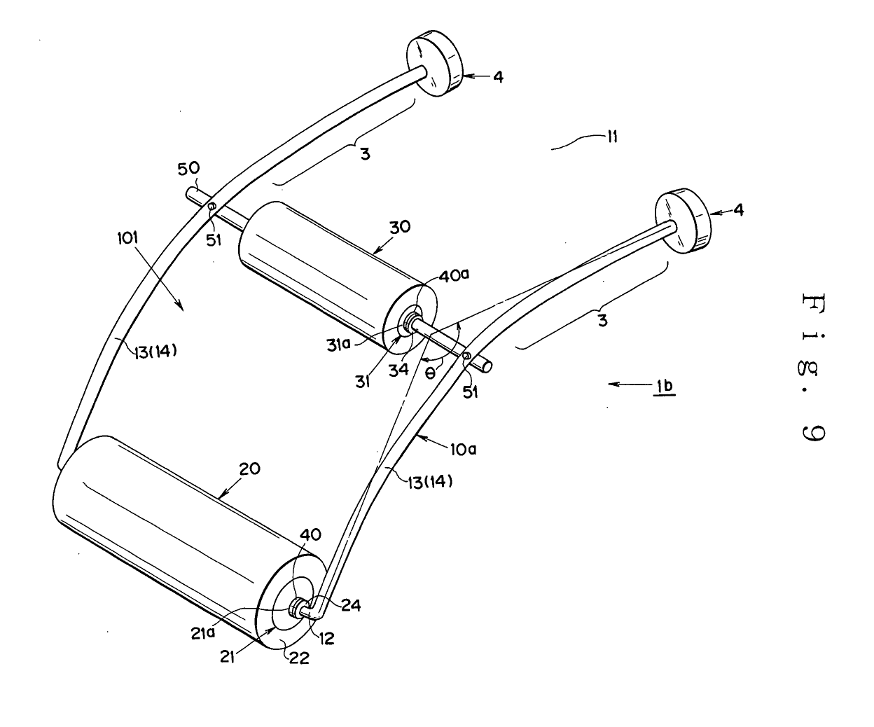

FIG. 9 illustrates the third embodiment (3) according to the present invention.

The massager in the third embodiment (3) comprises a stay member 10a having curved side portions 13 and 14 different from the stay member 10 in the first embodiment (1) in which the side portions of the stay member 10 serving as the operating parts 3 are bent at the angle of θ at the junctions 50.

The stay member 10a is generally formed in a square U shape similarly to the stay member in the aforementioned first embodiment (1) except the side portions 13 and 14 curved in an arc shape. The second roller 30 is supported by the curved side portions 13 and 14 of the stay member 10 at the junctions 50 similarly to the first embodiment (1) of the invention. The angle of inclination defined by the intersection of the tangent line extending from the end of the operating part 3 toward the second roller 30 and the tangent line extending from the side portion close to the base portion 12 supporting the first roller 20 toward the second roller 30 is set to the angle θ by the same structure as that described in the first embodiment (1). Other functions and effects of the massager in this embodiment are the same as those in the first embodiment (1) described above.

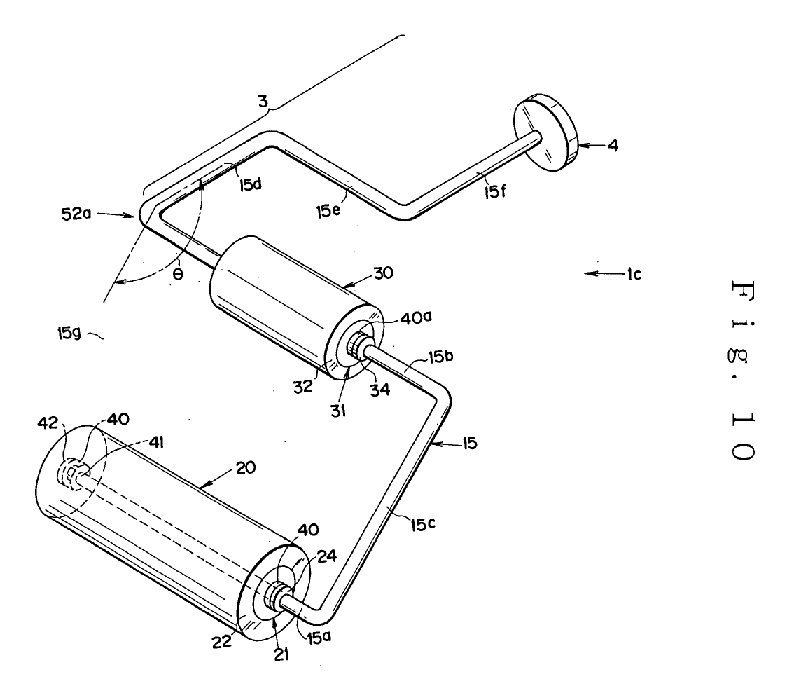

FIG. 10 illustrates the fourth embodiment (4) according to the present invention.

The massager in the fourth embodiment (4) has a single operating part 3, which may be equivalently formed by unifying the operating parts 3 with the handles 4 as seen in the first embodiment (1), so as to be operated with one hand. This massager 1c in this embodiment is applicable in massaging the arm.

The massager 1c in the fourth embodiment (4) comprises a substantial S-shaped stay member 15, first and second rollers 20 and 30 supported by the stay member 15, and a handle 4 attached to one end of the stay member 15 on the side of the second roller.

The stay member 15 is bent in the shape of a substantial S. The first and second rollers 20 and 30 are mounted on segments 15a and 15b. The operating part 3 with the handle 4 is positioned on the line defined by the substantial centers of the first and second rollers 20 and 30. The stay member is bent in such a manner that the segments 15f and 15d are oriented substantially parallel with each other, and the segments 15d and 15c are at an angle θ at a bent portion 52a like the structure in the first embodiment (1) described above. Other components of the massager in this embodiment are the same as those in the first embodiment (1) described above.

The massager 1c in the fourth embodiment (4) makes it possible to give rolling pressures brought about by the first and second rollers 20 and 30 to a not-shown arm from two directions at one time, which arm is inserted from a space 15g formed opposite to the segment 15c into between the first and second rollers 20 and 30, as is effected for the lower leg 200 in the foregoing embodiments. Of course, this massager can be applied for massaging the lower leg 200 with one hand, as in the first embodiment (1) and used for a variety of places of the user in an unrestrained posture. Thus, the operationality and portability of the massager of the invention are further improved.

The massager 1c in this embodiment may be produced by attaching the first and second rollers 20 and 30 to a straight stay and then bending the straight stay into a substantial S shape to form the bent stay member 15 with the rollers. Thus, the massager of the invention can easily be produced at substantially less manufacturing cost. Other functions and effects of the massager in this embodiment are the same as those in the first embodiment (1) described above.

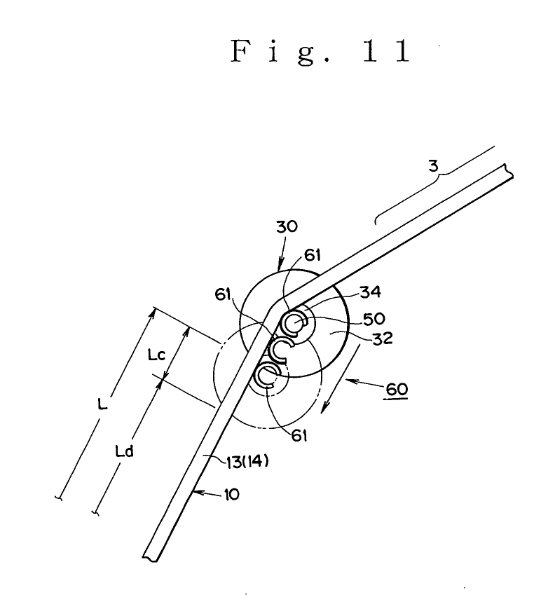

FIG. 11 illustrates the fifth embodiment (5) according to the present invention.

The massager in this fifth embodiment (5) further comprises a mount adjusting mechanism 60 disposed on the stay member 10 in addition to the components in the foregoing embodiments (1)-(3).

The mount adjusting mechanism 60 has a connection bar 50 supporting the second roller 30 and junctions 52 at which the connection bar is retained by the stay member 10. On each side portion 13 or 14 of the stay member 10, there are fixed a plurality of substantially C-shaped holders 61 each having an opening for receiving the connection bar 50. The holder 61 has an inner diameter substantially equal to the outer diameter of the connection bar 50 and may preferably be made of elastic material such as plastic and stainless steel, which has moderate elasticity for allowing the connection bar 50 to elastically pass through the opening in the holder 61 into the holder. Therefore, the connection bar 50 can be detachably fitted with elasticity from above into one of the holders 61 through the opening in the holder. The connection bar 50 may be inserted laterally into the holder 61 in the detachable state.

According to the massager in the fifth embodiment (5), the connection bar 50 can freely be attached to and detached from the stay member 10 so as to facilitate replacing of the second roller 30 with another roller having a protection member different in penetration rate for any purpose. Since the stay member 10 has the plurality of holders 61, the roller-to-roller distance L between the first and second rollers 20 and 30 can arbitrarily be shortened by the length Lc to the distance Ld by setting the connection bar 50 into the holders 61 closer to the side of the first roller 20, consequently to shorten the roller-to-roller distance L to conform to the shape of the lower leg 200 of a user to be massaged. Hence, the second roller can be detachably attached to the stay member and freely assembled with the stay member in accordance with the shape and size of the lower leg 200 of the user at the beginning of massaging. Thus, the massage of the invention has wide adaptive flexibility.

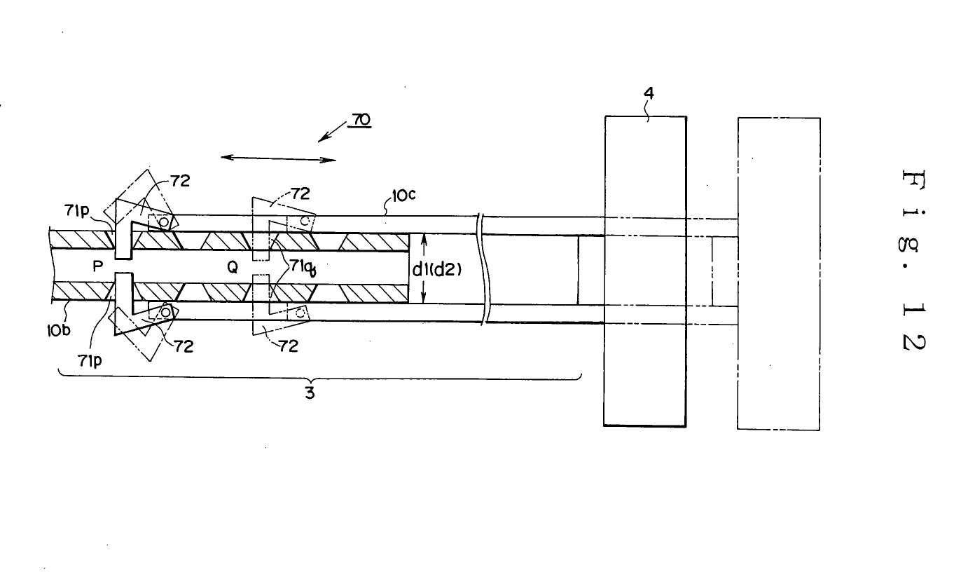

FIG. 12 illustrates the sixth embodiment (6) according to the present invention.

The massager in the sixth embodiment (6) has an extension adjusting mechanism 70 mounted on the operating part 3 of the stay member 10 as seen in the foregoing embodiments (1)-(3).

The extension adjusting mechanism 70 has a series of engaging holes 71 formed in the stay member 10 in the longitudinal direction and hooks 72 to be engaged into the engaging holes 71. By changing the engaging holes 71 for catching the hooks 72, the stay member 10 can extend or contract to change the length thereof.

The stay member 10 comprises a stay 10d having the engaging holes 71 and a stay 10c having the hooks 72. These stays 10c and 10d in this embodiment each are formed of a stainless steel pipe. The stay 10c has an inner diameter d1 substantially equal to the outer diameter d2 of the stay 10d, so that the stays 10c and 10d are telescopically united to allow the stay member 10 to slidingly extend and contract.

Therefore, adjusting of the length of the stay member 10 with the extension adjusting mechanism 70 can be carried out by first disengaging the hooks 72 in the state P from the holes 71p, sliding the stay 10c and then, engaging the hooks 72 into other holes 71q, consequently to lengthen the stay member 10 to the state Q as shown. In the state of engaging the hooks into the holes 71, the saccadic movement in the longitudinal direction of the stay member 10 can be prevented, so that bodily portions of the user to be massaged can be stably held in accordance with the posture, height, size and physical attribute of the user. Thus, the massager of the invention has good operationality and wide adaptive flexibility.

Whereas the extension adjusting mechanism 70 in the sixth embodiment (6) has high operationality of handling the operating part 3 of the stay member 10, the massager can enjoy higher operationality by disposing the extension adjusting mechanism 70 on the stay member 10 between the first and second rollers 20 and 30, so that the roller-to-roller distance can be arbitrarily adjusted to conform to the posture, height, size and physical attribute of the user before using the massager of the invention, consequently to bring about the same function and effect as in the foregoing embodiment (5).

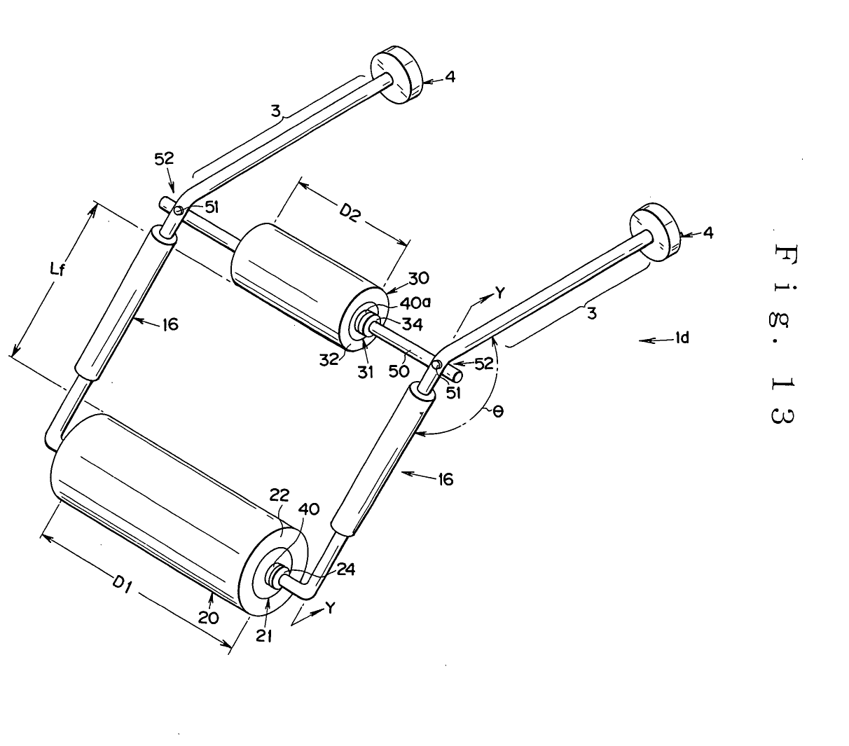

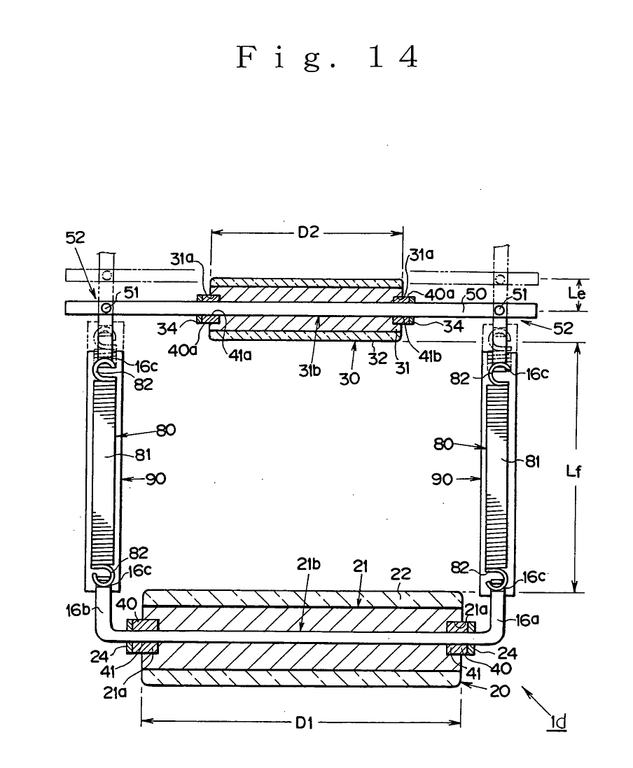

FIG. 13 and FIG. 14 illustrate the seventh embodiment (7) according to the present invention.

The seventh embodiment (7) provides a massager 1d with a stay member 16 formed by providing the stay 10 between the first and second rollers 20 and 30 in the first embodiment (1) with spring means.

The stay member 16 is generally formed in a square U shape similarly to that in the first embodiment (1) and provided between the first and second rollers 20 and 30 with spring members 80 covered with protective covers 90.

The segments 16a and 16c of the stay member 16 between the first and second rollers 20 and 30 have catch holes 16c for catching the spring members 80 described below in detail.

As shown in FIG. 14, the spring member 80 is formed of a spring material 81 having retaining hooks 82 at both ends thereof, so as to be retained onto the stay member 16 by engaging the hooks 82 into the catch holes 16 formed in the segments 16a and 16b of the stay member. It is preferable to make the spring member 80 of a steel spring having large spring modulus. The protective covers 90 enfolding the spring member 80 for protecting the arm and leg of the user may desirably be made of flexible material such as rubber.

The massager 1d thus constructed may be made shorter than that in the first embodiment (1) by the extensible length Le assured by the spring action of the spring member 80 so as to have a distance Lf from the first roller 20 to the connection bar 50.

In massaging with the massager 1d in this seventh embodiment (7), the massaging pressure exerted on the lower leg 200 held between the first and second rollers 20 and 30 is increased due to the spring action of the spring member 80. Besides, in adjusting the inclination of the stay member 16, the rollers can be rotatably moved along the lower leg 200 without exerting excessive rolling pressure on the lower leg 200 owing to the cushioning effect brought about by the spring members 80. Furthermore, the cushioning effect of the spring members 80 contributes to the operation for adjusting the inclination of the first and second rollers 20 and 30 relative to the base line G of the lower leg 200 in accordance of the differences in the shape and portion to be massaged in the lower leg 200 held between the rollers, consequently to effect smooth changing of the inclination of the stay member 16 by manipulating the operating parts 3. As a result, the massager of the invention can be effectively operated and permits an unrestrained posture of the user in handling and massaging. Since the spring members 81 are isolated from the lower leg 200 by the protective covers 90, the lower leg 200 can be protected from the spring members 81. Other functions and effects of the massager in this embodiment are the same as those in the first embodiment (1) described above.

Although not shown, there may be fabricated a structure combining the extension adjusting mechanism 70 in the foregoing embodiment (6) and the spring members 80. The massager comprising the combined structure and the basic structure including the first and second rollers 20 and 30 and the stay member 16 enjoys high adaptive flexibility as smooth adjustment of the roller-to-roller distance can easily be made due to elasticity of the spring members 81.

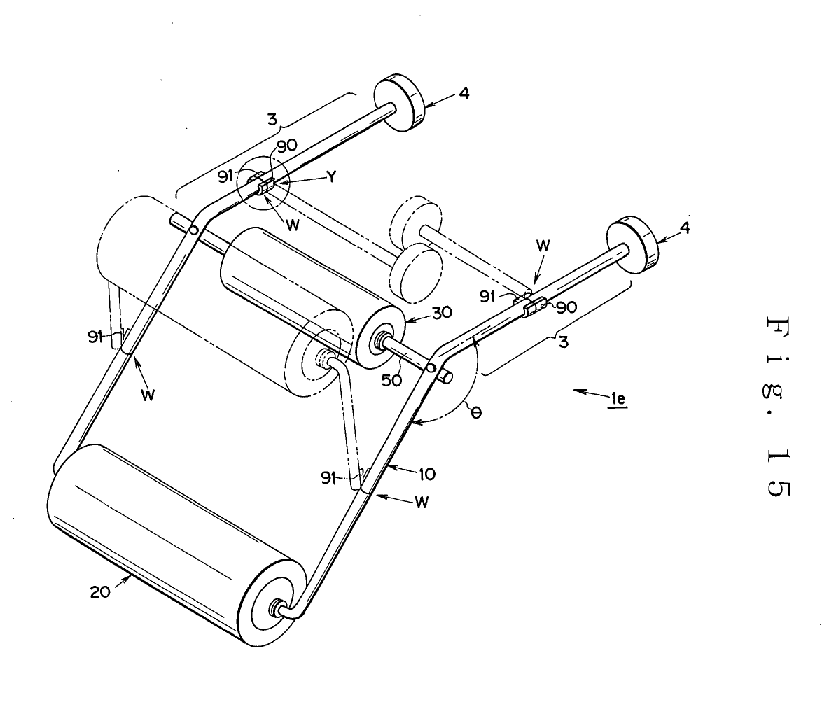

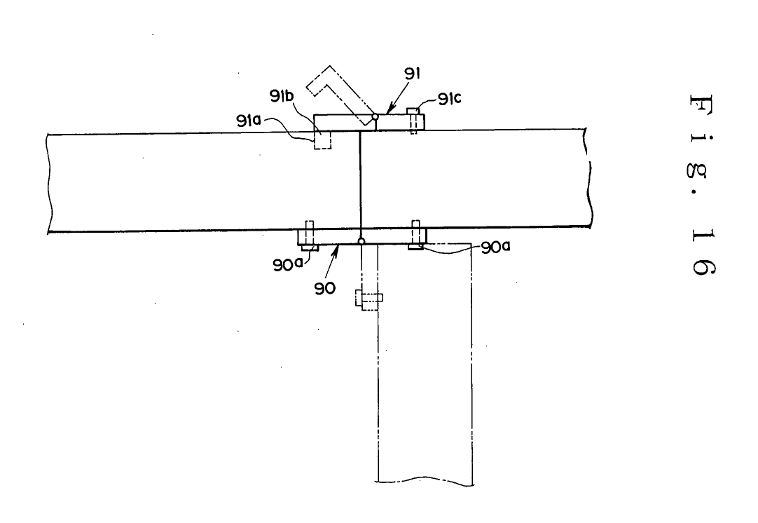

FIG. 15 and FIG. 16 illustrate the eighth embodiment (8) according to the present invention.

The massager in this eighth embodiment (8) has a foldable roller structure formed by arranging hinges 90 on the stay member 10 between the first and second rollers 20 and 30 so that it can be folded up in non-use.

The stay member 10 has the operating parts 3 and the first and second rollers 20 and 30 separated and joined at the points W through the hinges 90 with pins 90a. The massager can be folded by folding the operating parts 3 inwardly at the hinges 90 as shown in FIG. 15. Also, the stay member 10 is foldable at the hinges 90 between the first and second rollers 20 and 30.

As shown in FIG. 16, the foldable massager may have lock members 91 at the opposite portions to the hinges 90, so as not to fold the stay member 10 in use by engaging the lock members 91 into hook holes 91a formed in the stay member 10.

The massager 1e in the eighth embodiment (8) excels in portability because the stay member 10 is foldable to reduce its size for allowing for compact storage of the massager in non-use. That is, the massager can be folded up compactly so as to be stored in a desk drawer, bag or the like or carried in traveling or to a business office with ease. This mechanism may possibly be combined with the extension adjusting mechanism 70 in the aforesaid sixth embodiment (6). That is, the extension adjusting mechanism 70 may be attached to each of the operating parts 3 in the foldable massager so as to enable the massager to be folded more compactly upon shortening the stay member 10 by operating the extension adjusting mechanism. Other functions and effects of the massager in this embodiment are the same as those in the first embodiment (1) described above.

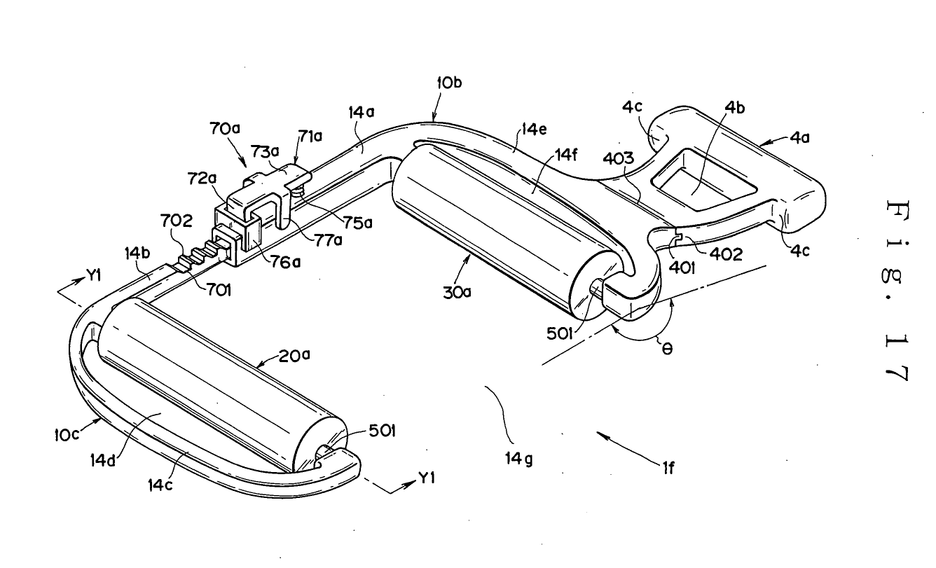

FIG. 17 through FIG. 21 illustrate the ninth embodiment (9) according to the present invention.

The massager 1f in the ninth embodiment (9) is obtained by further improving the foregoing embodiments (1), (4) and (6).

The massager 1f comprises stays 10b and 10c, first and second rollers 20a and 30a, operating part 3, and extension adjusting mechanism 70a. Other component parts are the same as those in the foregoing embodiments.

Similarly to the aforementioned embodiment (6), the stay 10b includes a stay 14a having the extension adjusting mechanism 70a and a hollow H for enabling expansion and construction of the stay member, and a stay 14b telescopically fitted into the hollow H, so that the stays 10b and 10c can be detachably connected with each other. These stays 10b and 10c and other elements may preferably be formed of thermoplastic resin or thermosetting resin, e.g. polycarbonate, polyamide, etc. The first roller 20a is detachably mounted onto the stay 10c, and the second roller 30a is detachably mounted on the stay 10b.

The stay 10c supporting the first roller 20a includes the stay 14c for holding the first roller 20a. The stay 14c is curved to form a space 14d so as not to come in contact with the first roller 20a for guarding the first roller 20a. Similarly, the stay 14e is curved to form a space 14f so as not to come in contact with the second roller 30a.

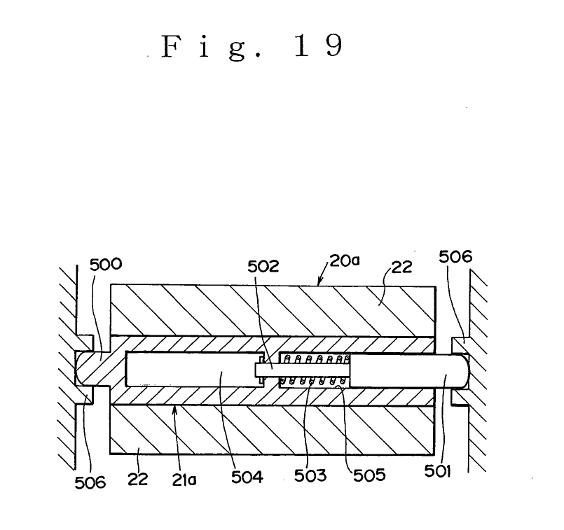

As shown in FIG. 19, the first roller 20a comprises a roller main body 21a and a protection member 22. The roller main body 21a has connection shafts 500 and 501, which are detachably fitted into shaft bushes 506 formed on the stay 14c. The connection shaft 501 is housed in the roller main body 21a and resiliently forced out by a spring 503. Hence, the connection shaft 501 is retreated by laterally moving the first roller 20a so as to compress the connection shaft 501, so that the first roller 20a can be detached with ease. With the spring 503 for constantly pushing the connection shaft 501 outward, the first roller 20a can steadily be supported by the stay 10c.

The shaft bush 506 formed on the stay 14c may preferably be formed of a ball bearing or the like for enabling smooth rotation of the first roller 20a, but it need not necessarily be the ball bearing inasmuch as the first roller 20a moves smoothly. Much the same is true on the second roller 30a.

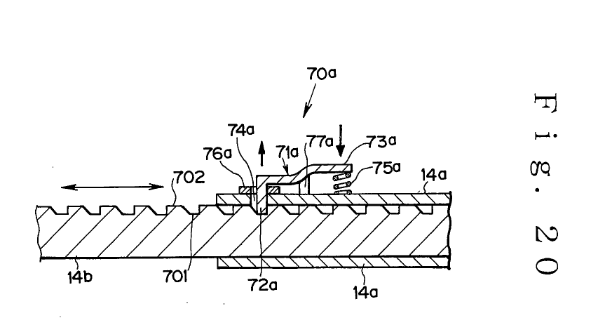

The extension adjusting mechanism 70a comprises an adjusting stopper 71a, and concave and convex portions 701 and 702 of the stay 14b. The adjusting stopper 71a has an engaging claw 72a for being engaged with one of the concave portions 701 through an engaging hole 74a. To ensure the engagement of the engaging claw 72a with the concave portion, it is desirable to dispose an engagement guide 76a on the stay 14a. The adjusting stopper 71a is further provided with a push member 73a for handling the engagement of the engaging claw 72a with one of the concave portions 701, and side pieces 77a placed on either side of the adjusting stopper 71a and fixed rotatably on the stay 14a. The side pieces 77a function as a fulcrum of a lever structure described later and serve to prevent wobbling of the adjusting stopper 71a. Between the push member 73a and the stay 14a, a spring 75a is disposed for steadily hooking the engaging claw 72a into one of the concave portions 701 by the action of the spring using the lever (the side pieces 77a functioning as the fulcrum). Thus, as shown in FIG. 20, the engaging claw 72a can be disengaged from the concave portion 77a by depressing the push member 73a to enable adjustment of the length of the stay 10c. By releasing the depressing force from the push member 73a, the push member 73a is forced up by the repulsive force of the spring 75a to bring the engaging claw 72a in steady engagement with the desired one of the concave portions 701. Of course, another fulcrum member may be disposed between the engaging claw 72a and the push member 73a in place of the side pieces 77a.

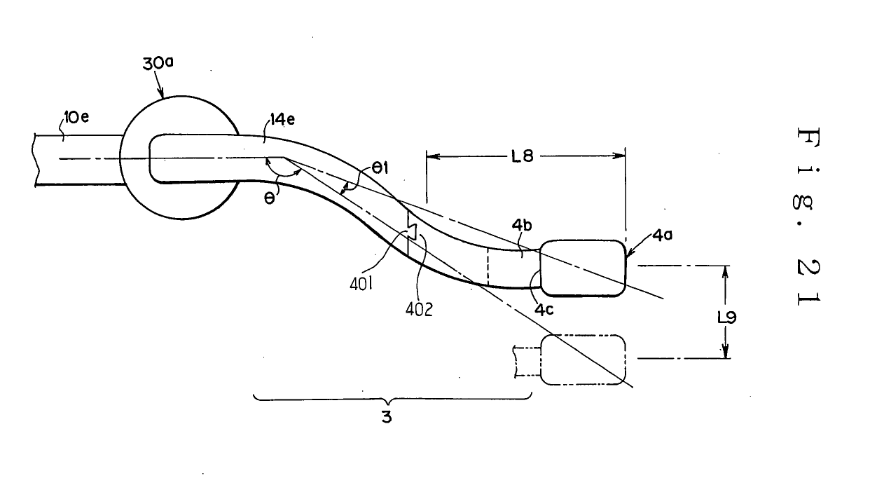

Similarly to the aforementioned embodiment (1), the stay 10b is bent or curved around the connection portion to the second roller 30a with inclination of θ of the stay member 10 relative to the operating part 3, the inclination of the stay 10b apart from the end portion (handle 4a) of the operating part 3 by a length L8 in this embodiment (9) should be made smaller than the inclination θ. That is, the inclination of the stay 10b apart from the end portion (handle 4a) of the operating part 3 by a length L8 should be θ+θ1, as shown in FIG. 21. The operating part 3 including the handle 4a is detachable from the stay 10b. As one example, the operating part 3 may be divided into two and detachably joined with each other by means of an interlocking structure composed of a projection 401 formed on the operating part-side end portion of one of the divided stay 10b and a counterpart groove 402 formed in the handle-side end portion of the other one of the divide stay.

Between the operating part 3 and the handle 4a, there is formed an insertion hole 4b for accepting a finger when holding the handle 4a. For instance, the insertion hole 4b may be formed so as to let the index finger and middle finger therethrough in case of seizing the handle 4a with a hand and locate the other fingers at the handle parts 4c.

According to the massager 1f in the ninth embodiment (9), the rollers can easily be replaced as the first and second rollers 20a and 30a are detachably mounted, consequently to enable most suitable massaging to conform to the user.

Besides, the adjustment using the extension adjusting mechanism 70a can easily be performed in a single operation with the adjusting stopper 71a, so that the distance of the first and second rollers 20a and 30a can be regulated with ease.

Furthermore, since the inclination of the stay 10b apart from the end portion of the operating part 3 by a length L8 in this embodiment (9) is made smaller than the inclination θ, smooth massaging operation can be practiced without bringing the operating part 3 and handle 4a in touch with the calf, femoral region or other parts of the user. (The inclination of the stay 10b apart from the end portion (handle 4a) of the operating part 3 by a length L8 is set to θ+θ1, the user can get an effective massage at a distance from the operating part 3. That is, the user being massaged with the massager of the invention is kept apart from the operating part 3 and handle 4a by the distance L9 shown in FIG. 21.)

Moreover, since the insertion hole 4b for accepting a finger is formed in the stay between the operating part 3 and the handle 4a, the handle 4a can be manipulated with high operationality. Other functions and effects of the massager in this embodiment are the same as those in the foregoing embodiments.

Since the operating part 3 with the handle 4a is detachable from the stay 10b, the handle 4a may be formed to the individual so as to increase individual operationality.

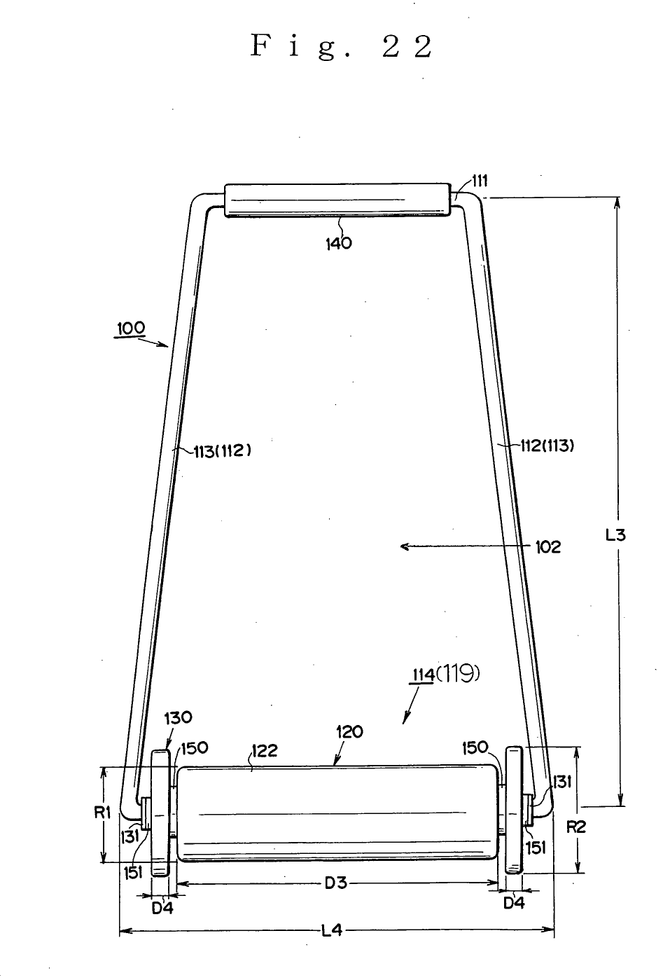

Next, FIG. 22 through FIG. 27 illustrate the tenth embodiment (10) with respect to the other mode of the massager according to the invention for applying a functional and effective massage to the lower leg.

The massager 100 in the tenth embodiment (10) serves to apply a massage principally to the lower leg.

The massager 100 comprises a stay member 110, a roller 120 supported by the stay member 110, and running wheels 130 disposed on either side of the roller 120.

The stay member 110 is formed by bending a steel pipe into a substantial square U shape to form a square insertion portion 102 framed by segments 111, 112 and 113 and an end portion 114 forming a mount part 119 for the roller 120. The insertion portion is increased in width from the segment 111 toward the mount part 119 (end portion 114). The insertion portion 102 has a length L3 extending from the segment 111 to the mount part 119 (end portion 114), which is longer than a length L4 of the mount part 119 (end portion 114) placed at the opening portion of the substantially U shaped stay member 110.

The roller 120 is composed of a roller main body 121, and a protection member 122 covering the roller main body 121. The roller has a diameter R1 defined by the diameter of the roller main body 121 and the thickness of the protection member 122. The roller main body 121 has a center groove 121a for receiving a bearing 150. The bearing 150 has a center hole 150a for receiving the stay member 110. The roller 120 has a width D3.

Each running wheel 130 has a diameter R2 larger than that of the roller 120 so as to be gripped with hand and is shaped like a cylinder having a width D3. The running wheel 130 has a center hole 131 for letting a bearing 151 thereinto. The bearing 151 has a center hole 151a for receiving the stay member 110. The running wheel 130 is rotatable independent of the roller 120 and mounted on the mount part 119 along with the roller 120. Each running wheel 130 is secured by a lock sleeve 131 for preventing rickety of the running wheel. The bearing 151 has a diameter smaller than that of the bearing 150.

The massager 100 thus constructed according to the invention, the roller 120 and running wheels 130 disposed through the bearings 150 and 151 and lock sleeves 131 on the mount part 119 (end portion 114) placed at the opening portion of the substantially U shaped stay member 110, and a cylindrical handle 140 disposed on the segment 111 for being gripped with hand. The roller and the handle are arranged substantially in parallel. Thus, the roller 120 and the running wheels 130 mounted on the stay member through the bearings 150 and 151 are rotatable independently. Since the bearings 150 and 151 have different diameters, independent rotations of the roller 120 and running wheels 130 are not precluded.

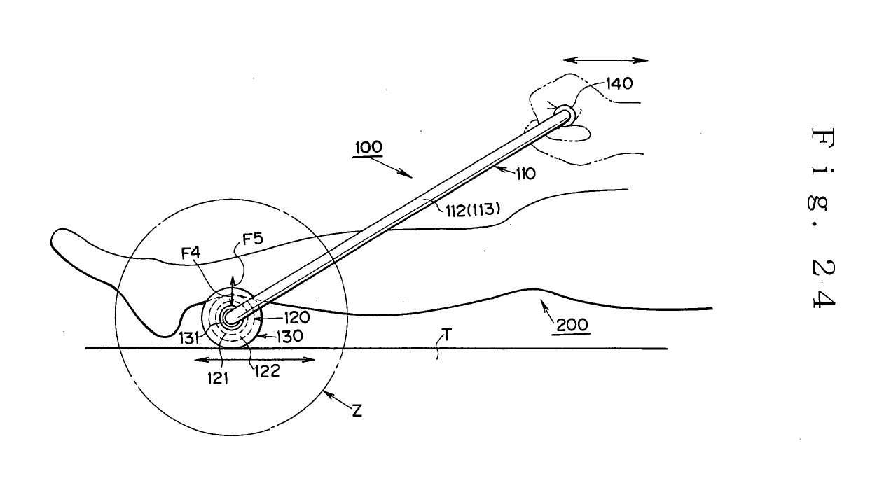

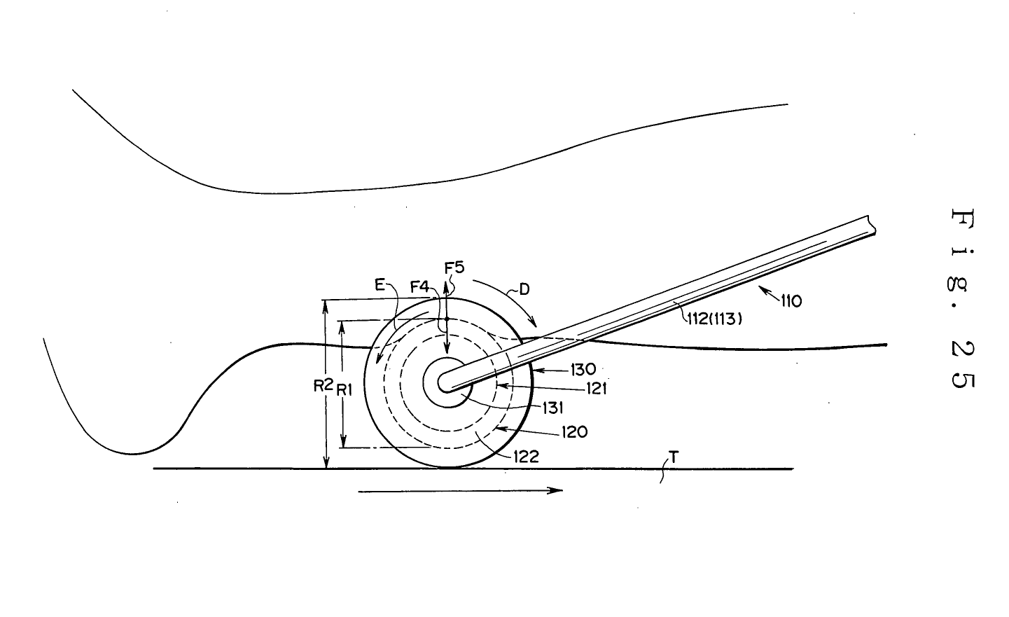

Next, the usage of the massager 100 will be described with reference to FIG. 24 and FIG. 25. FIG. 25 is an enlarged view of the part Z in FIG. 24, showing the state in which the roller 120 and running wheels 130 rotate in moving the roller 120 along the lower leg 200.

For a start, the running wheels 130 are placed on a floor T as shown in FIG. 24, and then, one of the lower legs 200 is inserted into the insertion portion 120 and put on the roller 120. In this state, the user sits on the floor T and gets a grip on the handle 140 with one hand.

As shown in FIG. 25, in moving the massager toward the upper leg 220 while gripping on the handle 140, the running wheels 130 rotate in the direction D as is in contact with the floor T, while the roller 120 in contact with the lower leg 200 through the protection member 122 rotates in the direction E opposite to the direction D in which the running wheels 130 rotate. Thus, as the running wheels 130 and the roller 120 rotate in the opposite directions, they can rotate independently at one time. Since the running wheels 130 each having a diameter R2 and the roller 120 having a diameter R1 have the relation R2>R1, the lower leg 200 smoothly receives rotating pressure brought about by the roller 120 due to difference in angular rate.

The massaging method thus described can apply a comfortable and suitable massage to the leg 200 by stably supporting the leg 200 on the roller 120 in conjunction with the running wheels 130 and using the reaction force F5 induced by the weight F4 of the leg 200. The insertion portion 102 for allowing insertion of the leg 200 thereinto has a length L3 extending from the segment 111 to the mount part 119 (end portion 114), which is longer than a length L4 of the mount part 119 (end portion 114) placed at the opening portion of the substantially U shaped stay member 110. Thus, the leg 200 put stably on the rotating roller 120 can be smoothly massaged by handling the operating part of the massager 100 by one hand.

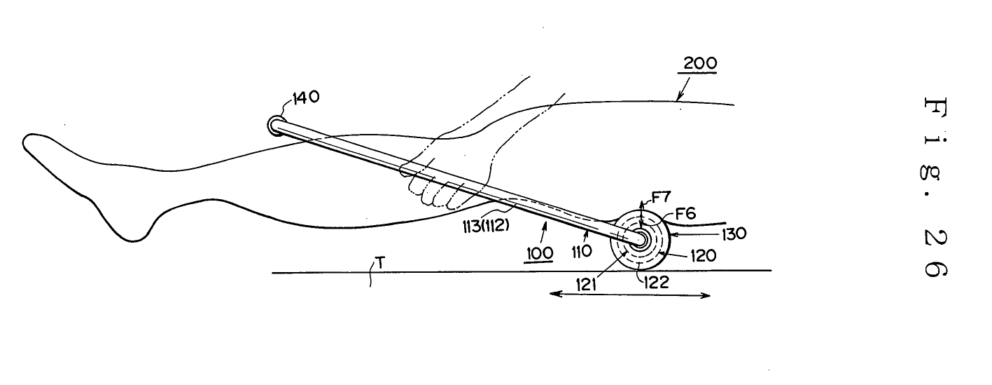

By placing the upper leg 220 on the roller 120 while bringing the running wheels 130 in contact with the floor T under the upper part 220 of the leg 200 as shown in FIG. 26, the reaction force F7 induced by the weight F6 of the leg can be applied as a massaging pressure to the upper leg. In this case, while gripping the handle 140 with one hand or both hands or the segments 112 and 113 of the stay member 110 with both hands, the massager is moved along the upper leg 220, consequently applying the massaging pressure to the upper leg.

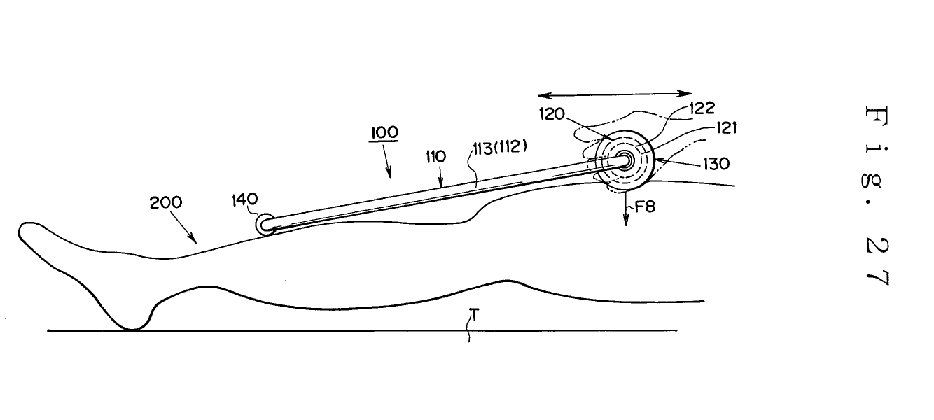

Alternatively, while gripping the running wheels 130 rotatable independent of the roller 120 in the state illustrated in FIG. 27 and applying a depressing force F8 to the roller rotating along the leg 200, a massaging pressure may be exerted on the leg 200. The rotating roller may possibly be moved along the side of the leg 200. Since the running wheels are made larger in diameter than the roller 120 and rotatable independent of the roller 120, the massaging pressure can easily be applied to the entire leg 200 in the state of gripping the running wheels 130. At this time, to facilitate gripping of the running wheels 130, although not shown, the stay member 110 may extend from between the roller 120 and the running wheels 130. However, the stay member 110 should not be limited to the structure illustrated in 22 inasmuch as the massager of the invention has the running wheels 130 disposed on either side of the roller 120 for putting the leg 200 thereon,

In the massager 100 in the embodiment (1) comprising the running wheels 130 each having a diameter R2 and the roller 120 having a diameter R1, the roller 120 is stably rotatable, so that a rolling pressure brought about by the roller 120 can be applied to the bodily parts, consequently to not only promote circulation of blood in the entire leg 200 and circulation of lymphocyte in a lymphatic system having no circulating pump corresponding to a heart in a blood circulating system, but also loosen up the muscles or the like. Thus, the massager of the invention makes it possible to renovate resiliency and flexibility of the leg 200. Besides, since the side segments 112 and 113 and the running wheels 130 are functioned as the operating parts 3 seen in the foregoing embodiment (1), since the portion to be held by the use can be changed in accordance of the type of usage, the massager of the invention can be effectively operated and permits an unrestrained posture of the user in handling and massaging.

Furthermore, since the distance L3 from the handle 140 to the roller 120 is made larger than the length L4 of the mount part 119 so as to facilitate insertion of the leg 200 into the insertion portion 102 framed by the stay member 110 and the roller 120, the roller 120 can securely move along the leg 200, applying an effective massaging pressure brought about by smooth movement of the massager 100 to the lower leg. The handle 140 formed on the operating part 3 is oriented substantially parallel with the roller 120, so that the direction in which the roller 120 moves along the leg 200 coincides with the direction in which the handle 140 is manipulated for moving the roller 120 along with the leg 200. Thus, the handle 140 secured in the state in which an operating force is given thereto by the user can easily be manipulated to move the roller 120 without bending the wrist of the user's hand holding the handle 140, consequently to enable a smooth massage applied to the leg 200.

In the method for applying a massaging pressure to the leg 200 inserted into the insertion portion 102, the roller 120 moves along the leg 200 put stably on the roller 120. In so doing, the roller 120 is directed in a suitable direction toward the portion to be successively massaged of the leg, consequently to enable an effective massage applied to the leg 200 without need for onerous operation. Thus, the massager in the state of inserting the leg 200 into the insertion portion can be stably operated by manipulating the handle 140 with one hand to apply an effective massage to the leg. When applying the massage to one of the legs 200 with the massager 100, the leg 200 is unconstrained so as to allow free movement of the upper body of the user without forcing the user being massaged to take a constrained posture in getting the massage, so that the bodily portion of the user to be massaged can freely be changed while readily applying the massage to the leg 200. That is, the user can flexibly move his or her upper body to do a stretching exercise and so on with accordance with the direction of moving the massager 100. In this way, the massager of the invention enables an effective massaging on only one of the legs 200, not both legs, by manipulating the operating part 140 with one hand.

Since the massager of the invention can be operated by gripping the running wheels 130 while pressing down the roller 120 onto the leg 200, a massaging pressure to be exerted on the leg can easily be obtained.

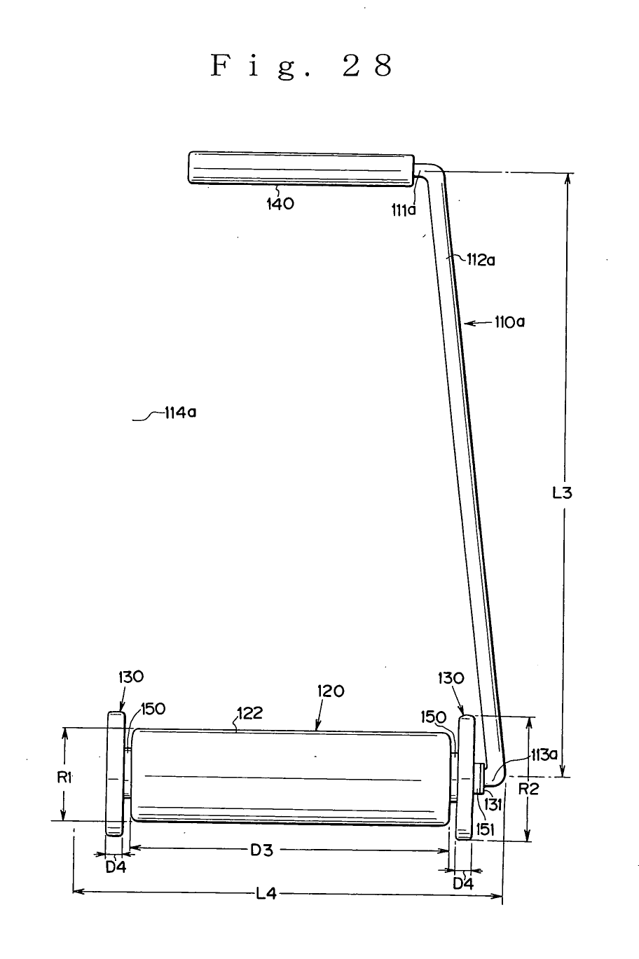

FIG. 28 shows the embodiment (11).

The embodiment (11) provides another massager, which has detachable roller 120 and running wheels 130 and differs from the massager 100 of the aforesaid embodiment (10) in the position of the roller mounted on the stay member 110.

The massager 100a in this embodiment (11) has the roller 120 attached to the segment 113a (mount part 119a) of the stay member 110a, which is formed in a substantial square U shape similarly to the stay member 100 in the foregoing embodiment (10), and a side opening 114a opening like a substantial U shape on the side of the roller 120. On the segment 111a, a handle 140 is formed. On either side of the roller 120, there are placed running wheels 130 similar to those seen in the foregoing embodiment (10).

Thus, the massager 100a in the embodiment (11) allows the leg 200 to be inserted into the inside of the stay member through the side opening 114a and positioned on the roller 120 with ease in order for applying a rolling pressure brought about by the roller to the leg. Since the roller 120 can easily be secured without deforming the stay member 120, a stable rolling pressure brought about by the roller 120 can be stably applied to the leg 200.

Moreover, since the roller 120 and running wheels 130 can be detachably attached to the stay member 110a through the side opening 114a, the roller 120 and running wheels 130 can easily be replaced in accordance with the shape of the portion to be massaged of the user. Thus, the massager 100a of the invention enjoys high applicability and easy maintenance of the roller 120 and running wheels 130, resultantly to provide the most suitable massaging effect. Other functions and effects of the massager in this embodiment are the same as those in the aforementioned embodiment (10) described above.

In addition to the illustrated embodiments, there may be suggested another massager having the running wheels 130 as seen in the embodiment (10) on either side of the first roller 20 as seen in the embodiment (1), so as to massage the user sitting on the floor. Furthermore, the running wheels 130 may be modified by covering their peripheral surfaces with cushion material in conformity with the usage of the massager (on the carpet or other flooring materials).

Although the operating part 3 of the stay member 10 is bent, the point at which the stay is bent should not be limited to the portion around the connection means 51, and the stay may be bent at multiple positions. The structure each of the foregoing embodiments is by no means limited to the illustrated modes.

As an alternative to the illustrated embodiments, there may be provided a massager having the stay 10, first and second rollers 20 and 30 and rollers 120 provided with eccentric motors to automatically rotate and vibrate the rollers, consequently to improve the massaging effect.

Moreover, the roller may have protrusions formed on the protection member covering the roller main body or soft and hard regions formed alternately on or in the surface of the roller, so as to have an acupressure effect on the arm or leg to be massaged.

Additionally, the roller 120 and first and second rollers 20 and 30 in the massager of the invention may be made of material generating infrared energy, to heighten the massaging effect owing to heat of the infrared energy. The protection member covering the roller may be subjected to antistatic treatment to prevent adherence of dust due to static electricity or antimicrobial treatment to prevent infestation of germs, so that a clean, innocuous massager can be provided. Furthermore, the stay 10 and/or rollers may be provided with fragrant materials or other chemicals to practice aromatherapy, so that the user can get an effective massage in a relaxed atmosphere. Like this, a variety of rollers may be used and the rollers may have any other desired shape.

Next, the present invention will described by some examples.

### PRACTICAL EXAMPLE 1

In the massager 1 shown in FIG. 1, the stay member 1 is made of a stainless steel pipe having a diameter of 5 mm, and similarly, the connection bar 50 is made of a stainless steel pipe having a diameter of 5 mm.

The roller main body 21 of the first roller 20 is made of wood and has a diameter of 30 mm and a width of about 150 mm. The protection member 22 covering the roller main body 21 is made of urethane or rubber with a penetration rate of about 100 and has a thickness of about 5 mm. The second roller 30 is made of the same material as the first roller 20 and comprises the roller main body having a diameter of about 15 mm, which is covered with the protection member with different penetration rate of about 80 from that of the first roller 20 and has a thickness of about 17 mm. In the center portions of the roller main bodies, there are bored center holes 21b and 31b for receiving the stay member 10 and the connection bar 50, respectively. At the end portions of the center holes 21b and 31b, there are formed side grooves 21a and 31a for accommodating the bearing 40 and 40a each having a diameter of about 10 mm. The penetration rates of the protection members of the rollers are determined in conformity with JIS K2530.

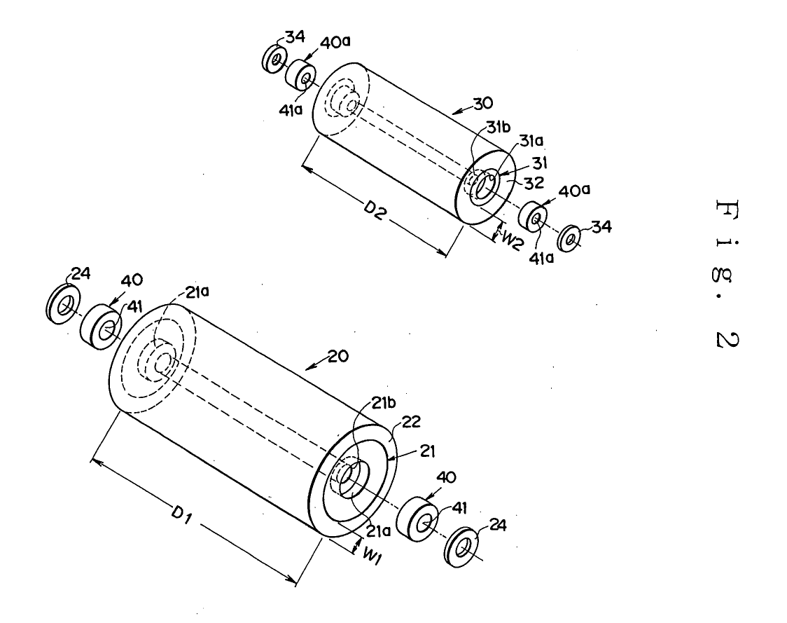

The first roller is attached to the stay 10 with the bearings 40 before bending the stay into a substantial square U shape as shown in FIG. 2. Then, the lock sleeves 24 each having a center hole of about 5 mm in diameter are assembled to prevent rickety of the first roller 20. Thereafter, the stay 10 is bent to have a width in conformity with the length of the first roller 20 into the desired substantial square U shape. In the same manner as the first roller, the second roller 30 is assembled to the connection bar 50 with the bearings 40a and lock sleeves 34 and secured onto the junctions 52 by means of the pins 51. The distance between the first roller 20 and the second roller 30 is about 900 mm.

The handles 4 at the ends of the operating parts 3 are each formed of a circular disc having a diameter of about 30 mm and a thickness of about 10 mm. The operating part 3 is bent at the connection bar 50 at an angle of 135° to 165°.

The massager 1 thus assembled is operated by manipulating the operating parts 3 to incline the stay member 10 to conform to the shape of the leg 200. In doing so, the stay member is inclined in such a state that the inclinations θa and θb of the first roller 20 and second roller 30 relative to the base line G of the leg 200 are adjusted to about 30° to 90°, and the roller-to-roller distance L′ is adjusted to about 450 mm (=½×L) to about 900 mm (=L), consequently to steadily hold parts of the leg 200. Thus, according to the massager, the leg 200 could be smoothly massaged with ease irrespective of the distance between the first roller 20 and the second roller 30, which is determined to about 900 mm.

Since the stay member 10 is bent at the junction 52 at an angle of 135° to 165°, the user could be effectively massaged in his stable posture without taking an uncomfortable body posture being close to the leg 200. Besides, the massager of the invention advantageously takes up little space in massaging and storing. It has been confirmed that the massager of the invention could give the users an effective massage with massaging pressures applied to the users from two directions at one time in very short period of time of about 5 minutes.

### PRACTICAL EXAMPLE 2

The massager 1f shown in FIG. 17 is different in configuration from that of the foregoing first Practical Example 1 and has the stays 10b and 10c, operating part 3 and handle 4a made of polycarbonate. The massager could be made light because the first and second rollers 20a and 30a are the same as those in the foregoing embodiment (9) and the extension adjusting mechanism 70a is made of thermoplastic resin or thermosetting resin as well as the stay 10b and the other parts.

The stay 14b has a width d3 of about 11 mm, and the hollow H for receiving the stay 14b has an inner diameter of about 11 mm equal to the width d3 of the stay. To secure the strength of the hollow H, the stay 14a has an outer diameter d4 of about 17 mm so as to assure a 3 mm thickness wall forming the hollow.

The insertion hole 4b formed between the operating part 3 and the handle 4a is formed in a trapezoid shape having a longitudinal length L′ of about 50 mm and a short side length of about 30 mm so as to allow two fingers to pass therethrough.

The operating part 3 is bent at the point from the end (handle 4a) of the operating part 3 by the distance L8 of about 75 mm at an angle θ+θ1 of about 160°.

Hence, the distance between the first roller 20 and the second roller 30 could be adjusted in a single operation, consequently to provide excellent handleability of the handle 4a with the insertion hole 4b and good operationality of the massager 1f.

Since the operating part 3 is bent at the point from the end (handle 4a) of the operating part 3 by the distance L8 of about 75 mm at an angle θ+θ1 of about 160°, smooth massaging operation could be practiced without bringing the operating part 3 and handle 4a in touch with the calf, femoral region or other parts of the user.

Since all the component parts are made of polycarbonate, a lightweight massager having excellent productivity and workability in being assembled could be realized.

### PRACTICAL EXAMPLE 3

The massager 100 shown in FIG. 22 comprises the stay 110 made of stainless steel pipe having a diameter of about 5 mm.

The roller main body 121 of the roller 120 is made of a wood rod having an outer diameter of about 30 mm and a length of about 160 mm. The protection member 122 covering the roller main body 121 is made of an elastic rubber or urethane sheet having a thickness of about 10 mm and a penetration rate of about 80. In the center portions of the roller main body 121, there are formed center holes 121a for accommodating the bearings 150 each having an outer diameter of about 15 mm.

Each of the running wheels 130 is formed of a wood circular disc having a thickness of about 10 mm and an outer diameter of about 65 mm and has a center hole 131a for accommodating the bearing 151 having a diameter of about 10 mm.

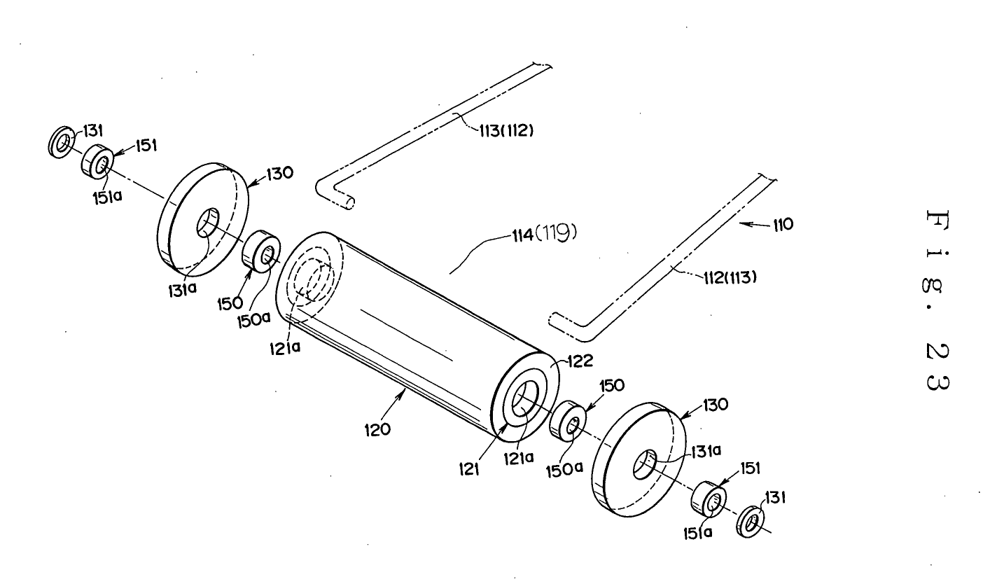

Thus, the massager 100 has the roller 120 and the running wheels 130 mounted rotatably independently as shown in FIG. 23. Similarly to the foregoing embodiment (1), the running wheels 130 and the roller 120 are steadily retained by means of the lock sleeves 131 assembled with the bearings 151, consequently to prevent rickety of the roller and running wheels in rotating. The stay 110 is formed in a substantial square U shape so as to have the segment 111 of about 140 mm in length and the opening side portion 114 of about 200 mm in width.

As just described, the massager has the roller 120 stably rotatable independent of the running wheels 130, consequently to enable an effective, smooth massage applied to the leg 200 placed on the roller 120. According to this massager, since the user being massaged can grip anywhere the side segments 112 and 113 of the stay 110 and running wheels 130, the position gripped by the user's hands can freely be changed in accordance with the state of usage. A high-performance massager having good operationality could be realized.

Furthermore, in the massager of the invention, the leg 200 of the user to be massaged can be placed in the insertion portion 102 with ease and effectively massaged by stably manipulating the handle 140 with one hand to move the roller along the leg 200. During massaging one of the legs of the user, the other leg of the user is unconstrained so as to allow free movement of the upper body of the user without forcing the user being massaged to take a constrained posture in getting the massage, so that the bodily portion of the user to be massaged can freely be changed while readily applying the massage to the leg 200.

### Industrial Applicability

As is apparent from the foregoing description, the massager in the best mode for carrying out the present invention makes it possible to readily apply an effective, smooth massage to the arm or leg placed between the rollers retained at a fixed distance in such a manner that the operating parts are manipulated to incline the stay member to conform to the shape of the arm or leg, adjusting the distance between the rollers with inclination of the stay member.

The massager of the invention comprises the first and second rollers so as to apply the rolling pressures brought about by the rollers to the arm or leg from two directions at one time, so that an effective massage can be applied to the entire arm or leg. Furthermore, since the massager of the invention makes use of the leverage action, a smooth massaging pressure force can be exerted on the arm or leg held by the rollers with a minimum force and adjusted with ease without weakening the massaging pressure.

Moreover, since the stay member of the massager of the invention is bent at the junctions and the operating parts can easily be handled during massaging, the massager of the invention can be used with taking up little space even on a train, airplane or the like in long periods of time and even in a business office or the like without taking up space.

According to the massager of the invention, the operationality of the massager is not diminished even in massaging the femoral region close to the upper body, so that the effective massage can be applied to the entire arm or leg by manipulating the operating parts to rotate the rollers.

The running wheels rotate coming in contact with the floor in massaging the leg, while independently rotating the roller covered with the protection member in contact with the leg in the direction opposite to that of the running wheels, so that the rolling pressure brought about by the roller can be applied along the leg. Since the roller and running wheels have different diameters to rotate at different angular rates, the roller can exert smooth rolling pressure on the leg and change in its position in accordance with the type of usage in massaging. Therefore, the massager of the invention can be effectively operated and permits an unrestrained posture of the user in handling and massaging.

According to the massaging method of the invention, which comprises inserting the arm or leg into the insertion portion and changing the inclination of the stay member by handling the operating part, the adjustment of the distance between the rollers can be effected without permitting the arm or leg to come off from the massager, thus bringing about an effect of securely rolling the rollers along the arm or leg to applying the effective rolling pressures to the arm or leg.

According to the massaging method of the invention, a sufficient, moderate massage can be applied to the leg stably placed on the roller disposed with the running wheels by use of the reaction force induced by the weight of the leg, consequently to not only promote circulation of blood in the entire leg and circulation of lymphocyte in a lymphatic system having no circulating pump corresponding to a heart in a blood circulating system, but also loosen up the muscles or the like, so that resiliency and flexibility of the leg 200 can be renovated. Besides, the rollers exerting the rolling pressures on the leg inserted into the insertion portion between the rollers can be moved in an appropriate direction relative to the part of the leg to be massaged without need for onerous operation.

When applying the massage to one of the legs with the massager, the leg is unconstrained so as to allow free movement of the upper body of the user without forcing the user being massaged to take a constrained posture in getting the massage, so that the bodily portion of the user to be massaged can freely be changed while readily applying the massage to the leg. That is, the user can flexibly move his or her upper body to do a stretching exercise and so on with accordance with the direction of moving the massager. In this way, the massager of the invention enables an effective massaging on only one of the legs, not both legs, by manipulating the operating part with one hand.

Furthermore, since the massager of the invention can be operated by gripping the running wheels while pressing down the roller onto the leg, a massaging pressure to be exerted on the leg can easily be obtained.

1. A massager comprising a stay member, an operating part formed on said stay member, and roller means rotatably supported by said stay member,
characterized in that said roller means is composed of a plurality of rollers, said operating part is formed in a direction in which said stay member between said rollers extends, wherein said stay member is changed in inclination to adjust the distance between said rollers to bring about a rolling pressure in accordance with the shape of an arm or leg of a user and regulate rolling pressure exerted on the arm or leg.

2. The massager according to claim 1, wherein said rollers are rotatable and freely movable along the arm or leg in multiple directions.

3. The massager according to claim 1, wherein said operating part is arranged at a desired angle relative to said direction in which said stay member between said rollers extends.

4. The massager according to claim 1, wherein said roller comprises a roller main body connected rotatably to said stay member, and a protection member covering said roller main body.

5. The massager according to claim 3, wherein said roller comprises a roller main body connected rotatably to said stay member, and a protection member covering said roller main body.

6. The massager according to claim 4, wherein said protection member is made of elastic materials having different penetration rates.

7. The massager according to claim 5, wherein said protection member is made of elastic materials having different penetration rates.

8. The massager according to claim 1, further comprising a mount adjusting mechanism for changing the locations of said rollers.

9. The massager according to claim 3, further comprising a mount adjusting mechanism for changing the locations of said rollers.

10. The massager according to claim 4, further comprising a mount adjusting mechanism for changing the locations of said rollers.

11. The massager according to claim 5, further comprising a mount adjusting mechanism for changing the locations of said rollers.

12. The massager according to claim 1, wherein said stay member is provided with an extension adjusting mechanism.

13. The massager according to claim 3, wherein said stay member is provided with an extension adjusting mechanism.

14. The massager according to claim 4, wherein said stay member is provided with an extension adjusting mechanism.

15. The massager according to claim 5, wherein said stay member is provided with an extension adjusting mechanism.

16. The massager according to claim 8, wherein said stay member is provided with an extension adjusting mechanism.

17. The massager according to claim 9, wherein said stay member is provided with an extension adjusting mechanism.

18. The massager according to claim 11, wherein said stay member is provided with an extension adjusting mechanism.

19. The massager according to claim 1, wherein said stay member placed between the rollers is provided with a spring member.

20. The massager according to claim 3, wherein said stay member placed between the rollers is provided with a spring member.

21. The massager according to claim 4, wherein said stay member placed between the rollers is provided with a spring member.

22. The massager according to claim 5, wherein said stay member placed between the rollers is provided with a spring member.

23. The massager according to claim 8, wherein said stay member placed between the rollers is provided with a spring member.

24. The massager according to claim 9, wherein said stay member placed between the rollers is provided with a spring member.

25. The massager according to claim 11, wherein said stay member placed between the rollers is provided with a spring member.

26. The massager according to claim 12, wherein said stay member placed between the rollers is provided with a spring member.

27. The massager according to claim 13, wherein said stay member placed between the rollers is provided with a spring member.

28. The massager according to claim 15, wherein said stay member placed between the rollers is provided with a spring member.

29. The massager according to claim 16, wherein said stay member placed between the rollers is provided with a spring member.

30. The massager according to claim 17, wherein said stay member placed between the rollers is provided with a spring member.

31. The massager according to claim 18, wherein said stay member placed between the rollers is provided with a spring member.

32. The massager according to claim 1, wherein said rollers are composed of a first roller mounted on one end of said stay member opposite to said operating part, and a second roller disposed between said operating part and said first roller, so as to hold the arm or leg with said first and second rollers from two directions.

33. The massager according to claim 3, wherein said rollers are composed of a first roller mounted on one end of said stay member opposite to said operating part, and a second roller disposed between said operating part and said first roller, so as to hold the arm or leg with said first and second rollers from two directions.

34. The massager according to claim 4, wherein said rollers are composed of a first roller mounted on one end of said stay member opposite to said operating part, and a second roller disposed between said operating part and said first roller, so as to hold the arm or leg with said first and second rollers from two directions.

35. The massager according to claim 5, wherein said rollers are composed of a first roller mounted on one end of said stay member opposite to said operating part, and a second roller disposed between said operating part and said first roller, so as to hold the arm or leg with said first and second rollers from two directions.

36. The massager according to claim 8, wherein said rollers are composed of a first roller mounted on one end of said stay member opposite to said operating part, and a second roller disposed between said operating part and said first roller, so as to hold the arm or leg with said first and second rollers from two directions.

37. The massager according to claim 9, wherein said rollers are composed of a first roller mounted on one end of said stay member opposite to said operating part, and a second roller disposed between said operating part and said first roller, so as to hold the arm or leg with said first and second rollers from two directions.

38. The massager according to claim 11, wherein said rollers are composed of a first roller mounted on one end of said stay member opposite to said operating part, and a second roller disposed between said operating part and said first roller, so as to hold the arm or leg with said first and second rollers from two directions.

39. The massager according to claim 12, wherein said rollers are composed of a first roller mounted on one end of said stay member opposite to said operating part, and a second roller disposed between said operating part and said first roller, so as to hold the arm or leg with said first and second rollers from two directions.

40. The massager according to claim 13, wherein said rollers are composed of a first roller mounted on one end of said stay member opposite to said operating part, and a second roller disposed between said operating part and said first roller, so as to hold the arm or leg with said first and second rollers from two directions.

41. The massager according to claim 15, wherein said rollers are composed of a first roller mounted on one end of said stay member opposite to said operating part, and a second roller disposed between said operating part and said first roller, so as to hold the arm or leg with said first and second rollers from two directions.

42. The massager according to claim 16, wherein said rollers are composed of a first roller mounted on one end of said stay member opposite to said operating part, and a second roller disposed between said operating part and said first roller, so as to hold the arm or leg with said first and second rollers from two directions.

43. The massager according to claim 17, wherein said rollers are composed of a first roller mounted on one end of said stay member opposite to said operating part, and a second roller disposed between said operating part and said first roller, so as to hold the arm or leg with said first and second rollers from two directions.

44. The massager according to claim 18, wherein said rollers are composed of a first roller mounted on one end of said stay member opposite to said operating part, and a second roller disposed between said operating part and said first roller, so as to hold the arm or leg with said first and second rollers from two directions.

45. The massager according to claim 19, wherein said rollers are composed of a first roller mounted on one end of said stay member opposite to said operating part, and a second roller disposed between said operating part and said first roller, so as to hold the arm or leg with said first and second rollers from two directions.

46. The massager according to claim 20, wherein said rollers are composed of a first roller mounted on one end of said stay member opposite to said operating part, and a second roller disposed between said operating part and said first roller, so as to hold the arm or leg with said first and second rollers from two directions.

47. The massager according to claim 22, wherein said rollers are composed of a first roller mounted on one end of said stay member opposite to said operating part, and a second roller disposed between said operating part and said first roller, so as to hold the arm or leg with said first and second rollers from two directions.

48. The massager according to claim 23, wherein said rollers are composed of a first roller mounted on one end of said stay member opposite to said operating part, and a second roller disposed between said operating part and said first roller, so as to hold the arm or leg with said first and second rollers from two directions.

49. The massager according to claim 24, wherein said rollers are composed of a first roller mounted on one end of said stay member opposite to said operating part, and a second roller disposed between said operating part and said first roller, so as to hold the arm or leg with said first and second rollers from two directions.

50. The massager according to claim 25, wherein said rollers are composed of a first roller mounted on one end of said stay member opposite to said operating part, and a second roller disposed between said operating part and said first roller, so as to hold the arm or leg with said first and second rollers from two directions.

51. The massager according to claim 27, wherein said rollers are composed of a first roller mounted on one end of said stay member opposite to said operating part, and a second roller disposed between said operating part and said first roller, so as to hold the arm or leg with said first and second rollers from two directions.

52. The massager according to claim 28, wherein said rollers are composed of a first roller mounted on one end of said stay member opposite to said operating part, and a second roller disposed between said operating part and said first roller, so as to hold the arm or leg with said first and second rollers from two directions.

53. A massager comprising a stay member, an operating part formed on said stay member, and roller means rotatably supported by said stay member,
characterized in that said operating part has a handle arranged substantially parallel to said roller means, said roller means is provided on its both sides with running wheels rotatable independent of said roller means, said roller means is integrally assembled with said running wheels on a mount part formed in said stay, so as to define an insertion portion framed by said stay member and said roller means for allowing the arm or leg to be inserted thereinto, said running wheels being larger in diameter than said roller means, said roller means being rotatable along an arm or leg of a user independent of said running wheels, wherein a relation between a distance L3 from said handle to said roller means and a length L4 of said mount part is defined by L3>L4.

54. A massager comprising a stay member, an operating part formed on said stay member, and roller means rotatably supported by said stay member,
characterized in that said operating part has a handle arranged substantially parallel to said roller means, said roller means is provided with running wheels, said roller means is integrally assembled with said running wheels on a mount part formed in said stay, so as to define an insertion portion framed by said stay member and said roller means for allowing the arm or leg to be inserted thereinto, wherein said running wheels are detachable and made larger in diameter than said roller means.

55. (canceled)

56. The massager according to claim 54, wherein a relation between a distance L3 from said handle to said roller means and a length L4 of said mount part is defined by L3>L4.

57. (canceled)

58. The massager according to claim 53, wherein said running wheels are detachable.

59. (canceled)

60. (canceled)

61. (canceled)

62. A massaging method using a massager comprising a stay member, an operating part formed on said stay member, and rollers rotatably supported by said stay member,
characterized by inserting an arm or leg of a user into an insertion portion framed by said stay member and rollers, handling said operating parts extending longitudinally from said stay member placed between said rollers so as to change said stay member in inclination to adjust the distance between said rollers, and rotating said rollers along the arm or leg to bring a rolling pressure on the arm or leg from all directions at one time.

63. A massaging method using a massager comprising a stay member, an operating part formed on said stay member, and roller means rotatably supported by said stay member and integrally provided on its both sides with running wheels, characterized by inserting the arm or leg into an insertion portion framed by said stay member and said roller means to put the arm or leg on said roller means, and permitting said roller means to come in contact with the arm or leg and move along the arm or leg on said roller means, and moving said roller means along the arm or leg independent of said running wheels to apply a rolling pressure to the arm or leg.

64. A massaging method using a massager comprising a stay member, an operating part formed on said stay member, and roller means rotatably supported by said stay member and integrally provided on its both sides with running wheels having larger diameter than that of said roller means and rotatble independent of the roller means, characterized by gripping said running wheels while pressing said roller means onto the arm or leg, and moving said roller means along the arm or leg independent of said running wheels to apply a rolling pressure to the arm or leg.

65. The massager according to claim 2, wherein said operating part is arranged at a desired angle relative to said direction in which said stay member between said rollers extends.

66. The massager according to claim 2, wherein said roller comprises a roller main body connected rotatably to said stay member, and a protection member covering said roller main body.

67. The massager according to claim 2, further comprising a mount adjusting mechanism for changing the locations of said rollers.

68. The massager according to claim 6, further comprising a mount adjusting mechanism for changing the locations of said rollers.

69. The massager according to claim 7, further comprising a mount adjusting mechanism for changing the locations of said rollers.

70. The massager according to claim 2, wherein said stay member is provided with an extension adjusting mechanism.

71. The massager according to claim 6, wherein said stay member is provided with an extension adjusting mechanism.

72. The massager according to claim 7, wherein said stay member is provided with an extension adjusting mechanism.

73. The massager according to claim 10, wherein said stay member is provided with an extension adjusting mechanism.

74. The massager according to claim 2, wherein said stay member placed between the rollers is provided with a spring member.

75. The massager according to claim 6, wherein said stay member placed between the rollers is provided with a spring member.

76. The massager according to claim 7, wherein said stay member placed between the rollers is provided with a spring member.

77. The massager according to claim 10, wherein said stay member placed between the rollers is provided with a spring member.

78. The massager according to claim 14, wherein said stay member placed between the rollers is provided with a spring member.

79. The massager according to claim 2, wherein said rollers are composed of a first roller mounted on one end of said stay member opposite to said operating part, and a second roller disposed between said operating part and said first roller, so as to hold the arm or leg with said first and second rollers from two directions.

80. The massager according to claim 6, wherein said rollers are composed of a first roller mounted on one end of said stay member opposite to said operating part, and a second roller disposed between said operating part and said first roller, so as to hold the arm or leg with said first and second rollers from two directions.

81. The massager according to claim 7, wherein said rollers are composed of a first roller mounted on one end of said stay member opposite to said operating part, and a second roller disposed between said operating part and said first roller, so as to hold the arm or leg with said first and second rollers from two directions.

82. The massager according to claim 10, wherein said rollers are composed of a first roller mounted on one end of said stay member opposite to said operating part, and a second roller disposed between said operating part and said first roller, so as to hold the arm or leg with said first and second rollers from two directions.

83. The massager according to claim 14, wherein said rollers are composed of a first roller mounted on one end of said stay member opposite to said operating part, and a second roller disposed between said operating part and said first roller, so as to hold the arm or leg with said first and second rollers from two directions.

84. The massager according to claim 21, wherein said rollers are composed of a first roller mounted on one end of said stay member opposite to said operating part, and a second roller disposed between said operating part and said first roller, so as to hold the arm or leg with said first and second rollers from two directions.

85. The massager according to claim 26, wherein said rollers are composed of a first roller mounted on one end of said stay member opposite to said operating part, and a second roller disposed between said operating part and said first roller, so as to hold the arm or leg with said first and second rollers from two directions.

86. The massager according to claim 29, wherein said rollers are composed of a first roller mounted on one end of said stay member opposite to said operating part, and a second roller disposed between said operating part and said first roller, so as to hold the arm or leg with said first and second rollers from two directions.

87. The massager according to claim 30, wherein said rollers are composed of a first roller mounted on one end of said stay member opposite to said operating part, and a second roller disposed between said operating part and said first roller, so as to hold the arm or leg with said first and second rollers from two directions.

88. The massager according to claim 31, wherein said rollers are composed of a first roller mounted on one end of said stay member opposite to said operating part, and a second roller disposed between said operating part and said first roller, so as to hold the arm or leg with said first and second rollers from two directions.
